(19) United States
(12) Patent Application Publication
(10) Pub. No.: US 2025/0139313 A1
(43) Pub. Date: May 1, 2025

(54) METHOD AND SYSTEMS FOR LIVE DIGITAL TWIN VISUALIZATION

(71) Applicant: PassiveLogic, Inc., Holladay, UT (US)

(72) Inventor: Troy Aaron Harvey, Brighton, UT (US)

(21) Appl. No.: 18/496,548

(22) Filed: Oct. 27, 2023

(51) Int. Cl. G06F 30/13; G06F 111/02; G06T 11/60

(52) U.S. Cl. CPC G06F 30/13; G06T 11/60; G06F 2111/02

(57) ABSTRACT

Various embodiments relate to a method and related device and machine-readable storage medium including one or more of the following: receiving, via a first user interface scene, a user specification of a physical structure; committing a data representation of the physical structure to a digital twin; transmitting the digital twin to a remote device; receiving an update to the digital twin from the remote device, producing an updated digital twin; and rendering, via a second user interface scene, a graphical representation of the updated digital twin.

### TECHNICAL FIELD

Various embodiments described herein relate to applications for creation of or interaction with digital twins and more particularly, but not exclusively, to live visualization of data in connection with a digital twin.

### BACKGROUND

While various approaches to capturing a description of a building, whether planned or already built, in digital form exist, the uses for these digital models tend to be limited. A drawing of a building created by a designer is useful for showing that drawing and not much else. If simulations are to be run by another party, a different digital representation suited to that application must then be constructed. Furthermore, once created, a digital model in these applications has served its purpose and does not offer much further insight through later stages of building development or management.

### SUMMARY

Accordingly, various embodiments described herein present a digital twin that may be used across multiple applications, throughout the lifetime of building development and management. At the time of initially designing a building, the user's drawing tools translate directly to a functional digital twin that is useful for simulation and live visualization of data. Further, by enabling other applications and devices such as on premise building controllers to use, update, and improve the digital twin, these application functionality are further improved. In particular, where the digital twin can be informed with live data from the physical structures it represents, live visualizations can be presented to a user, providing a new kind of “operational” building information model to better inform management decisions. Various additional technical benefits will be apparent in view of the following disclosure.

Various embodiments relate to a method for providing a live visualization including one or more of the following: receiving, via a first user interface scene, a user specification of a physical structure; committing a data representation of the physical structure to a digital twin; transmitting the digital twin to a remote device; receiving an update to the digital twin from the remote device, producing an updated digital twin; and rendering, via a second user interface scene, a graphical representation of the updated digital twin.

Various embodiments relate to a device for providing a live visualization including one or more of the following: a memory capable of storing a digital twin; a communication interface; a user interface; and a processor configured to: receive, via a first user interface scene presented via the user interface, a user specification of a physical structure; commit a data representation of the physical structure to a digital twin in the memory; transmit the digital twin to a remote device via the communication interface; receive an update to the digital twin from the remote device, producing an updated digital twin; and render, via a second user interface scene presented via the user interface, a graphical representation of the updated digital twin.

Various embodiments relate to a non-transitory machine-readable medium encoded with instructions for execution by a processor for providing a live visualization including one or more of the following: instructions for receiving, via a first user interface scene, a user specification of a physical structure; instructions for committing a data representation of the physical structure to a digital twin; instructions for transmitting the digital twin to a remote device; instructions for receiving an update to the digital twin from the remote device, producing an updated digital twin; and instructions for rendering, via a second user interface scene, a graphical representation of the updated digital twin.

Various embodiments are described wherein: the update comprises at least one live value from a real-world environment represented by the digital twin, and the graphical representation comprises a graphical representation of the at least one live value.

Various embodiments are described wherein the at least one live value comprises at least one live measurement, the method further comprising: using the at least one live measurement to interpolate measurement values across the physical structure, wherein the graphical representation comprises a graphical overlay representing the measurement values across the physical structure.

Various embodiments additionally include receiving a user specification of a measurement device location relative to the physical structure; wherein using the at least one live measurement to interpolate measurement values across the physical structure comprises associating a measurement of the at least one live measurement with the device location.

Various embodiments are described wherein: the digital twin comprises a set of functions modeling a behavior associated with the physical structure; the update comprises a modification of at least one function of the set of function; the method further comprises performing a simulation of the behavior using the set of functions as modified; and the graphical representation comprises a display of a result of the simulation.

Various embodiments additionally include identifying a weather data source associated with a location of a real-world environment associated with the physical structure, wherein performing the simulation comprises simulating an effect of weather on the physical structure using weather data from the weather data source.

Various embodiments are described wherein the remote device is an on-premise controller device installed at a real-world environment associated with the physical structure.

Various embodiments described herein relate to a method for computer aided building design, including one or more of the following: receiving, via a first user interface scene, a user drawing of a physical structure; translating the user drawing to a digital twin comprising a data representation of the physical structure and a set of functions modeling a behavior associated with the physical structure; rendering, via the first user interface scene, the digital twin into a graphical representation of the physical structure; performing a first simulation of the behavior using the set of functions from the digital twin; displaying, via a second user interface scene, a result of the first simulation; receiving, via the first user interface scene, a user modification to the user drawing; modifying the set of functions in the digital twin based on the user modification; performing a second simulation of the behavior using the set of functions as modified in the digital twin; and displaying, via the second user interface scene, a result of the second simulation.

Various embodiments described herein relate to a device for computer aided building design, the device including one or more of the following: a user interface; a memory capable of storing a digital twin; and a processor configured to: receive, via a first user interface scene presented via the user interface, a user drawing of a physical structure; translate the user drawing to a digital twin stored in the memory, the digital twin comprising a data representation of the physical structure and a set of functions modeling a behavior associated with the physical structure; render, via the first user interface scene, the digital twin into a graphical representation of the physical structure; perform a first simulation of the behavior using the set of functions from the digital twin; display, via a second user interface scene presented via the user interface, a result of the first simulation; receive, via the first user interface scene, a user modification to the user drawing; modify the set of functions in the digital twin based on the user modification; perform a second simulation of the behavior using the set of functions as modified in the digital twin; and display, via the second user interface scene, a result of the second simulation.

Various embodiments described herein relate to a non-transitory machine-readable storage medium encoded with instructions for execution by a processor for computer aided building design, including one or more of the following: instructions for implementing a computer aided design application including: instructions for receiving, via a first user interface scene, a user drawing of a physical structure, instructions for translating the user drawing to a digital twin comprising a data representation of the physical structure and a set of functions modeling a behavior associated with the physical structure, instructions for rendering, via the first user interface scene, the digital twin into a graphical representation of the physical structure, instructions for receiving, via the first user interface scene, a user modification to the user drawing, and instructions for modifying the set of functions in the digital twin based on the user modification; instructions for implementing a simulation application including: instructions for performing a simulation of the behavior using the set of functions from the digital twin, and instructions for displaying, via a second user interface scene, a result of the simulation; and instructions for enabling a user to switch back and forth between the first user interface scene and the second user interface scene, whereby modifications to the digital twin made via the computer aided design application are made available to the simulation application for performing the simulation.

Various embodiments are described wherein the behavior is a propagation of heat through the physical structure.

Various embodiments additionally include identifying a weather data source associated with a location of a real-world environment associated with the physical structure, wherein performing the first simulation and the second simulation comprise simulating an effect of weather on the physical structure using the weather data source and the set of equations.

Various embodiments additionally include obtaining surrounding geometry data associated with a location of a real-world environment associated with the physical structure, wherein performing the first simulation and performing the second simulation comprise simulating light exposure of the physical structure based on the surrounding geometry data.

Various embodiments additionally include rendering, via at least one of the second interface scene and a third interface scene, a graphical representation of the physical structure; receiving, from the user, specification of additional geometry data at a location relative to the graphical representation of the physical structure; wherein simulating light exposure of the physical structure based on the surrounding geometry data is additionally based on the additional geometry data.

Various embodiments are described wherein displaying the result of the second simulation comprises displaying a graphical representation of sun exposure together with a graphical representation of the physical structure.

Various embodiments are described wherein performing the first simulation and performing the second simulation further comprise simulating at least one temperature within the physical structure based on the set of equations and the simulated light exposure.

### BRIEF DESCRIPTION OF THE DRAWINGS

In order to better understand various example embodiments, reference is made to the accompanying drawings, wherein:

FIG. 1 illustrates an example system for implementation of various embodiments;

FIG. 2 illustrates an example device for implementing a digital twin application suite;

FIG. 3 illustrates an example digital twin 300 for construction by or use in various embodiments;

FIG. 4 illustrates an example hardware device for implementing a digital twin application device;

FIG. 5 illustrates an example sequence of operations for creating and using a digital twin;

FIG. 6A illustrates a first example workspace illustrating a drawing tool;

FIG. 6B illustrates an example digital twin translated from drawing tool input;

FIG. 6C illustrates a second example workspace illustrating a rendering of a digital twin;

FIG. 7 illustrates an example method for implementing a design application main loop;

FIG. 8 illustrates an example method for translating user drawing input into a digital twin update;

FIG. 9 illustrates an example user interface scene for providing a site planning application;

FIG. 10 illustrates an example method for implementing a site planner application main loop;

FIG. 11 illustrates an example user interface scene for providing a simulate application;

FIG. 12 illustrates an example method for implementing a simulate application main loop;

FIG. 13 illustrates an example method for performing a simulation;

FIG. 14 illustrates an example user interface scene for providing an analysis application; and

FIG. 15 illustrates an example method for implementing an analysis application main loop.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or,” as used herein, refers to a non-exclusive or (i.e., and/or), unless otherwise indicated (e.g., “or else” or “or in the alternative”). Additionally, the various embodiments described herein are not necessarily mutually exclusive and may be combined to produce additional embodiments that incorporate the principles described herein.

### Overview

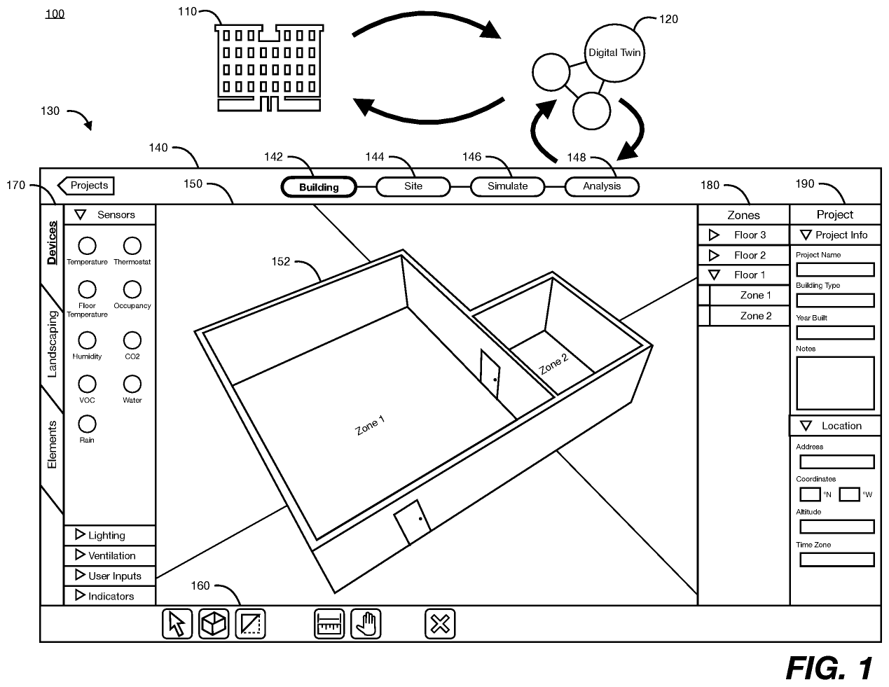

FIG. 1 illustrates an example system 100 for implementation of various embodiments. As shown, the system 100 may include an environment 110, at least some aspect of which is modeled by a digital twin 120. The digital twin 120, in turn, interacts with a digital twin application suite 130 for providing a user with various means for interaction with the digital twin 120 and for gaining insights into the real-world environment 110. According to one specific set of examples, the environment 110 is a building or other physical structure while the digital twin 120 models various aspects of that building such as, for example, the building structure, its climate conditions (e.g., temperature, humidity, etc.), and a system of controllable heating, ventilation, and air conditioning (HVAC) equipment.

While various embodiments disclosed herein will be described in the context of such an HVAC application or in the context of building design and analysis, it will be apparent that the techniques described herein may be applied to other applications including, for example, applications for controlling a lighting system, a security system, an automated irrigation or other agricultural system, a power distribution system, a manufacturing or other industrial system, or virtually any other system that may be controlled. Further, the techniques and embodiments may be applied other applications outside the context of controlled systems or environments 110 that are buildings. Virtually any entity or object that may be modeled by a digital twin may benefit from the techniques disclosed herein. Various modifications to adapt the teachings and embodiments to use in such other applications will be apparent.

The digital twin 120 is a digital representation of one or more aspects of the environment 110. In various embodiments, the digital twin 120 is implemented as a heterogenous, omnidirectional neural network. As such, the digital twin 120 may provide more than a mere description of the environment 110 and rather may additionally be trainable, computable, queryable, and inferencable, as will be described in greater detail below. In some embodiments, one or more processes continually, periodically, or on some other iterative basis adapts the digital twin 120 to better match observations from the environment 110. For example, the environment 110 may be outfitted with one or more temperature sensors that provide data to a building controller (not shown), which then uses this information to train the digital twin to better reflect the current state or operation of the environment. In this way, the digital twin is a “living” digital twin that, even after initial creation, continues to adapt itself to match the environment 110, including adapting to changes such as system degradation or changes (e.g., permanent changes such as removing a wall and transient changes such as opening a window).

Various embodiments of the techniques described herein may use alternative types of digital twins than the heterogenous neural network type described in most examples herein. For example, in some embodiments, the digital twin 120 may not be organized as a neural network and may, instead, be arranged as another type of model for one or more components of the environment 110. In some such embodiments, the digital twin 120 may be a database or other data structure that simply stores descriptions of the system aspects, environmental features, or devices being modeled, such that other software has access to data representative of the real world objects and entities, or their respective arrangements, as the software performs its functions.

As shown, the digital twin application suite 130 currently displays an interface scene for providing user access to and interaction with a building design application. This building design application may be used for various purposes such as for designing a building to be built (e.g., before the building 110 has been built) or for designing renovations or retrofits to an existing building. As will be explained in greater detail below, the design of a building using this building design application drives creation or modification of the digital twin 120 itself. As such, the building design application may also be used as a digital twin creator, to capture the structure of an existing building 110 in the digital twin 120, so that the digital twin 120 can be used by other applications (including those provided by the digital twin application suite 130 or by other external applications such as a controller that autonomously controls the HVAC or other controllable system of the environment 110).

The digital twin application suite's 130 current interface scene includes a collection of panels, including a navigation panel 140, a workspace 150, a tool panel 160, a library panel 170, an exploration panel 180, and a project information panel 190. Various alternative embodiments will include a different set of panels or other overall graphical interface designs that enable access to the applications, tools, and techniques described herein.

As noted, the digital twin application suite 130 may display only one interface scene of a multi-interface suite or software package. The navigation panel 140 includes a set of ordered indicators 142, 144, 146, 148 conveying a workflow for design, simulation, and analysis using a digital twin 120 and the various applications of the application suite 130. These include a Building indicator 142 associated with a building design application and associated interface scene(s); a Site indicator 144 associated with a site planning application and associated interface scene(s); a Simulate indicator 146 associated with a simulation application and associated interface scene(s); and an Analysis indicator 148 associated with a live building analysis application and associated interface scene(s). The Building indicator 142 has an altered appearance compared to the other indicators 144, 146, 148 (here, bold text and thick outer lines, but any alteration can be used) to indicate that it is the presently active step or application, and is associated with the presently-displayed interface scene. In some embodiments, visual or other cues can be used to indicate additional workflow information: that the steps associated with indicators have been completed, that the current step is ready or not ready to be completed, that there is a problem with a step associated with an indicator, etc.

In some embodiments, the indicators 142, 144, 146, 148 may be interface buttons that enable, upon user click, tap, or other selection, the user to change the interface scene to another interface scene associated with the selected indicator 142, 144, 146, 148. In other embodiments, additional or alternative controls may enable the user to change the interface scene. According to various embodiments, each of the applications provided as part of the digital twin application suite 130 may read, modify, or otherwise utilize the same digital twin 120. In particular, in some embodiments, the digital twin application suite 130 may initially be launched or accessed in the context of a single digital twin or project with which a digital twin is associated. Thus, the user may be able to switch back and forth between the different applications to access different application functionalities vis a vis the digital twin 120. For example, the user may create an initial building design (and, consequently, digital twin 120) with the design application, switch to the simulate application to simulate HVAC behavior of the building, then switch back to the design application to make design changes taking into account the simulation results. Because the digital twin 120 is constructed in a way that it can support each of these disparate applications, the applications can be constructed to natively operate with the same digital twin format and to be presented together as a single suite in the context of a particular digital twin instance. Changes to the digital twin on one application may thus be made available to other applications immediately, without any translation to a different format, without loading the digital twin into a different set of software, and without necessitating moving the digital twin from one memory location to another. As such, an improved workflow for is offered for users of a single application suite 130 rather than switching between multiple different applications with different learning curves, running on different underlying data organization formats, and potentially originating from different vendors.

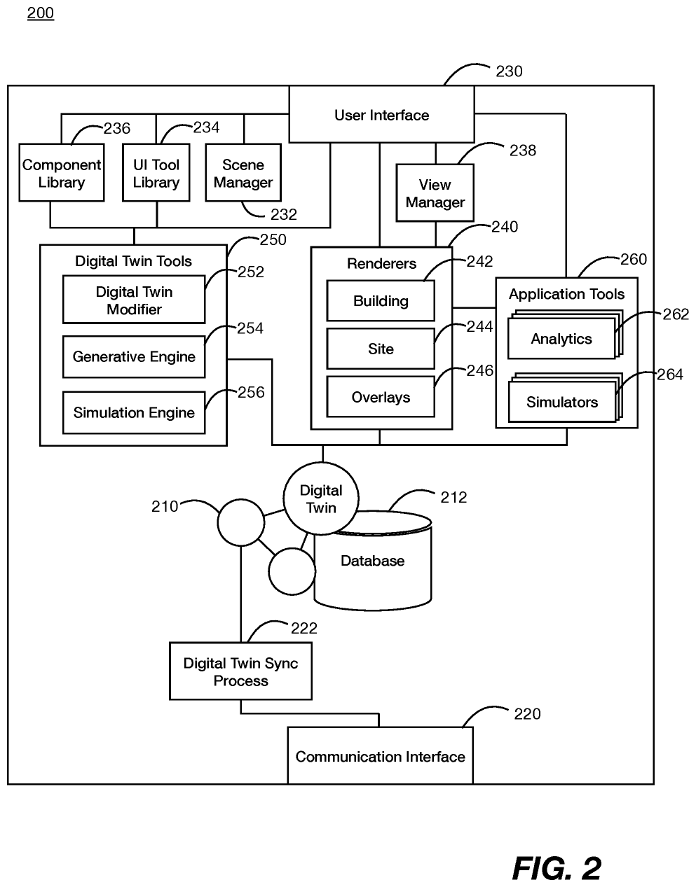

Having described the example environment 100 of various embodiments, particular details of the examples software architectures, digital twin constructions, and hardware arrangements will now be described with reference to FIGS. 2-5, before returning to FIG. 1 to describe specific details of the design application as pictured.

FIG. 2 illustrates an example device for implementing a digital twin application suite 200. The digital twin application device 200 may correspond to the device that provides digital twin application suite 130 and, as such, may provide a user with access to one or more applications for interacting with a digital twin.

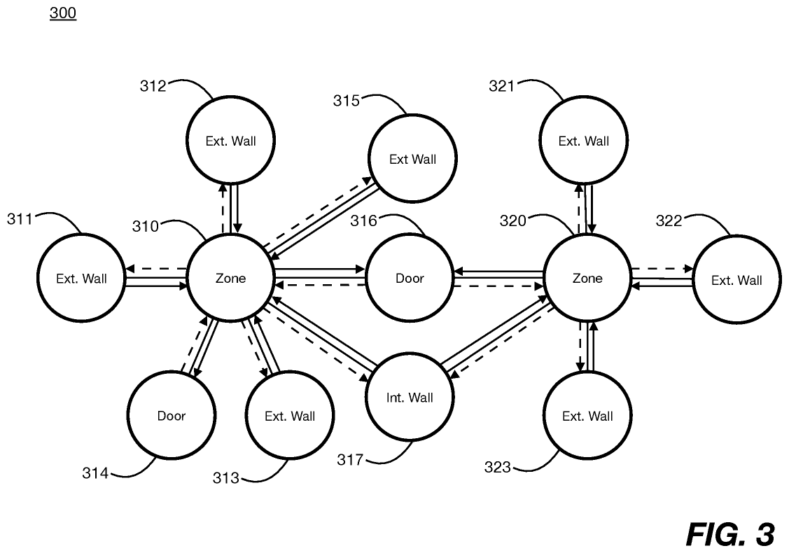

The digital twin application device 200 includes a digital twin 210, which may be stored in a database 212. The digital twin 210 may correspond to the digital twin 120 or a portion thereof (e.g., those portions relevant to the applications provided by the digital twin application device 200). The digital twin 210 may be used to drive or otherwise inform many of the applications provided by the digital twin application device 200. A digital twin 210 may be any data structure that models a real-life object, device, system, or other entity. Examples of a digital twin 210 useful for various embodiments will be described in greater detail below with reference to FIG. 3. While various embodiments will be described with reference to a particular set of heterogeneous and omnidirectional neural network digital twins, it will be apparent that the various techniques and embodiments described herein may be adapted to other types of digital twins. In some embodiments, additional systems, entities, devices, processes, or objects may be modeled and included as part of the digital twin 210.

In some embodiments, the digital twin 210 may be created and used entirely locally to the digital twin application device 200. In others, the digital twin 210 may be made available to or from other devices via a communication interface 220. The communication interface 220 may include virtually any hardware for enabling connections with other devices, such as an Ethernet network interface card (NIC), WiFi NIC, Bluetooth interface, or USB interface.

A digital twin sync process 222 may communicate with one or more other devices via the communication interface 220 to maintain the state of the digital twin 210. For example, where the digital twin application device 200 creates or modifies the digital twin 210 to be used by other devices, the digital twin sync process 222 may send the digital twin 210 or updates thereto to such other devices as the user changes the digital twin 210. Similarly, where the digital twin application device 200 uses a digital twin 210 created or modified by another device, the digital twin sync process 222 may request or otherwise receive the digital twin 210 or updates thereto from the other devices via the communication interface 220, and commit such received data to the database 212 for use by the other components of the digital twin application device 200. In some embodiments, both of these scenarios simultaneously exist as multiple devices collaborate on creating, modifying, and using the digital twin 210 across various applications. As such, the digital twin sync process 222 (and similar processes running on such other devices) may be responsible for ensuring that each device participating in such collaboration maintains a current copy of the digital twin, as presently modified by all other such devices. In various embodiments, this synchronization is accomplished via a pub/sub approach, wherein the digital twin sync process 222 subscribes to updates to the digital twin 210 and publishes its own updates to be received by similarly-subscribed devices. Such a pub/sub approach may be supported by a centralized process, such as a process running on a central server or central cloud instance.

To enable user interaction with the digital twin 210, the digital twin application device 200 includes a user interface 230. For example, the user interface 230 may include a display, a touchscreen, a keyboard, a mouse, or any device capable of performing input or output functions for a user. In some embodiments, the user interface 230 may instead or additionally allow a user to use another device for such input or output functions, such as connecting a separate tablet, mobile phone, or other device for interacting with the digital twin application device 200. In some embodiments, the user interface 230 includes a web server that serves interfaces to a remote user's personal device (e.g., via the communications interface). Thus, in some embodiments, the applications provided by the digital twin application device 200 may be provided as a web-based software-as-a-service (SaaS) offering.

The user interface 230 may rely on multiple additional components for constructing one or more graphical user interfaces for interacting with the digital twin 210. A scene manager 232 may store definitions of the various interface scenes that may be offered to the user. As used herein, an interface scene will be understood to encompass a collection of panels, tools, and other GUI elements for providing a user with a particular application (or set of applications). For example, four interface scenes may be defined, respectively for a building design application, a site analysis application, a simulation application, and a live building analysis application. It will be understood that various customizations and alternate views may be provided to a particular interface scene without constituting an entirely new interface scene. For example, panels may be rearranged, tools may be swapped in and out, and information displayed may change during operation without fundamentally changing the overall application provided to the user via that interface scene.

The UI tool library 234 stores definitions of the various tools that may be made available to the user via the user interface 230 and the various interface scenes (e.g., by way of a selectable interface button). These tool definitions in the UI tool library 234 may include software defining manners of interaction that add to, remove from, or modify aspects of the digital twin. As such, tools may include a user-facing component that enables interaction with aspects of the user interface scene, and a digital twin-facing component that captures the context of the user's interactions, and instructs the digital twin modifier 252 or generative engine 254 to make appropriate modifications to the digital twin 210. For example, a tool may be included in the UI tool library 234 that enables the user to create a zone. On the UI side, the tool enables the user to draw a square (or other shape) representing a new zone in a UI workspace. The tool then captures the dimensions of the zone and its position relative to the existing architecture, and passes this context to the digital twin modifier 252, so that a new zone can be added to the digital twin 210 with the appropriate position and dimensions.

A component library 236 stores definitions of various digital objects that may be made available to the user via the user interface 230 and the various interface scenes (e.g., by way of a selection of objects to drag-and-drop into a workspace). These digital objects may represent various real-world items such as devices (e.g., sensors, lighting, ventilation, user inputs, user indicators), landscaping, and other elements. The digital objects may include two different aspects: an avatar that will be used to graphically represent the digital object in the interface scene and an underlying digital twin that describes the digital object at an ontological or functional level. When the user indicates that a digital twin should be added to the workspace, the component library provides that object's digital twin to the digital twin modifier 252 so that it may be added to the digital twin 210.

A view manager 238 provides the user with controls for changing the view of the building rendering. For example, the view manager 238 may provide one or more interface controls to the user via the user interface to rotate, pan, or zoom the view of a rendered building; toggle between 2D and 3D renderings; or change which portions (e.g., floors) of the building are shown. In some embodiments, the view manager may also provide a selection of canned views from which the user may choose to automatically set the view to a particular state. The user's interactions with these controls are captured by the view manager 238 and passed on to the renderers 240, to inform the operation thereof.

The renderers 240 include a collection of libraries for generating the object representations that will be displayed via the user interface 230. In particular, where a current interface scene is specified by the scene manager 232 as including the output of a particular renderer 240, the user interface 230 may activate or otherwise retrieve image data from that renderer for display at the appropriate location on the screen.

Some renderers 240 may render the digital twin (or a portion thereof) in visual form. For example, the building renderer 242 may translate the digital twin 210 into a graphical representation of one or more floors of the building it represents. The manner in which this is performed may be driven by the user via settings passed to the building renderer via the view manager. For example, depending on the user input, the building renderer may generate a 2D plan view of floors 2, 3, and 4; a 3D isometric view of floor 1 from the southwest corner; or a rendering of the exterior of the entire building.

Some renderers 240 may maintain their own data for rendering visualizations. For example, in some embodiments, the digital twin 210 may not store sufficient information to drive a rendering of the site of a building. For example, rather than storing map, terrain, and architectures of surrounding buildings in the digital twin 210, the site renderer 244 may obtain this information based on the specified location for the building. In such embodiments, the site renderer may obtain this information via the communication interface 220, generate intermediate description of the surrounding environment (e.g., descriptions of the shapes of other buildings in the vicinity of the subject building), and store this for later user (e.g., in the database 212, separate from the digital twin). Then, when the user interface 230 calls on the site renderer 244 to provide a site rendering, the site renderer 244 uses this intermediate information along with the view preferences provided by the view manager, to render a visualization of the site and surrounding context. In other embodiments where the digital twin 210 does store sufficient information for rendering the site (or where other digital twins are available to the digital twin application device 200 with such information), the site renderer 244 may render the site visualization based on the digital twin in a manner similar to the building renderer 240.

Some renderers 240 may produce visualizations based on information stored in the digital twin (as opposed to rendering the digital twin itself). For example, the digital twin 210 may store a temperature value associated with each zone. The overlay renderer 246 may produce an overlay that displays the relevant temperature value over each zone rendered by the building renderer 242. Similarly, some renderers 240 may produce visualizations based on information provided by other components. For example, an application tool 260 may produce an interpolated gradient of temperature values across the zones and the overlay renderer 246 may produce an overlay with a corresponding color-based gradient across the floors of each zone rendered by the building renderer 242.

A set of digital twin tools 216 may provide various libraries for enabling or enhancing other device 200 component interactions with the digital twin 210. For example, as noted above, while various tools in the UI tool library 234 provide a user experience of interacting directly with the various renderings shown in the interface scene, these tools actually provide a means to manipulate the digital twin 210. These changes are then picked up by the renderers 240 for display. To enable these changes to the digital twin 210, the digital twin tools 250 may include a digital twin modifier 252 library. The digital twin modifier 252 may be capable of various modifications such as adding new nodes to the digital twin; removing nodes from the digital twin; modifying properties of nodes; adding, changing, or removing connections between nodes; or adding, modifying, or removing sets of nodes (e.g., as may be corelated to a digital object in the component library 236). In many instances, the user instructs the digital twin modifier 252 what changes to make to the digital twin 210 (via the user interface 230, UI tool library 234, or other component). For example, a tool for adding a zone, when used by the user, directly instructs the digital twin modifier to add a zone node and wall nodes surrounding it to the digital twin. As another example, where the user interface 230 provides a slider element for modifying an R-value of a wall, the user interface 230 will directly instruct the digital twin to find the node associated with the selected wall and change the R-value thereof.

In some cases, one or more contextual, constraint-based, or otherwise intelligent decisions are to be made in response to user input to determine how to modify the digital twin 210. These more complex modifications to the digital twin 210 may be handled by the generative engine 254. For example, when a new zone is drawn, the walls surrounding it may have difference characteristics depending on whether they should be interior or exterior walls. This decision, in turn, is informed by the context of the new zone in relation to other zones and walls. If the wall will be adjacent another zone, it should be interior; if not, it should be exterior. In this case, the generative engine 254 may be configured to recognize specific contexts and interpret them according to, e.g., a rule set to product the appropriate modifications to the digital twin 210.

As another example, in some embodiments, a tool may be provided to the user for generating structure or other object based on some constraint or other setting. For example, rather than using default or typical roof construction, the user may specify that the roof should be dome shaped. Then, when adding a zone to the digital twin, the generative engine may generate appropriate wall constructions and geometries, and any other needed supports, to provide a structurally-sound building. To provide this advanced functionality, the generative engine 254 may include libraries implementing various generative artificial intelligence techniques. For example, the generative engine 254 may add new nodes to the digital twin, create a cost function representing the desired constraints and certain tunable parameters relevant to fulfilling those constraints, and perform gradient descent to tune the parameters of the new nodes to provide a constraint (or other preference) solving solution.

The digital twin tools 250 may also provide a simulation engine 256 for performing various simulations using the digital twin 256. For example, the simulation engine 256 may, on request by another component, propagate state (e.g., temperature, humidity, pressure, etc.) or other quanta (e.g., mechanical energy, thermal energy, fluid, control signals, data, etc., depending on the system(s) modeled by the digital twin 210) through the various nodes according to the activation functions therebetween, to simulate a future state of the digital twin (and thus the real-world system modeled by the digital twin). To simulate further into the future, the simulation engine 256 may iteratively perform this propagation over a series of timesteps until the desired point in the future is reached.

Various interface scenes may provide access to additional application tools 260 beyond means for modifying the digital twin and displaying the results. As shown, some possible application tools include one or more analytics tools or simulators 264. The analytics tools 262 may provide advanced visualizations for showing the information captured in the digital twin 262. As in an earlier mentioned example, an analytics tool 262 may interpolate temperatures across the entire footprint of a floorplan, so as to enable the overlay renderer 246 to provide an enhanced view of the temperature of the building compared to the point temperatures that may be stored in each node of the digital twin 210. In some embodiments, these analytics and associated overlay may be updated in real time. To realize such functionality, a separate building controller (not shown) may continually or periodically gather temperature data from various sensors deployed in the building. These updates to that building controller's digital twin may then be synchronized to the digital twin 210 (through operation of the digital twin sync process 222), which then drives updates to the analytics tool.

As another example, an analytics tool 262 may extract entity or object locations from the digital twin 210, so that the overlay renderer 246 can then render a live view of the movement of those entities or objects through the building. For example, where the building is a warehouse, inventory items may be provided with RFID tags and an RFID tracking system may continually update its version of the building digital twin with inventory locations. Then, as this digital twin is continually or periodically synced to the local digital twin 210, the object tracking analytics tool 262 may extract this information from the digital twin 262 to be rendered. In this way, the digital twin application device 200 may realize aspects of a live, operational BIM.

The application tools 260 may also include one or more simulators 264. As opposed to the analytics tools 262 which focus on providing informative visualizations of the building as it is, the simulator tools 264 may focus on predicting future states of the building or predicting current states of the building that are not otherwise captured in the digital twin 210. For example, a shadow simulator 264 may use the object models used by the site renderer to simulate shadows and sub exposure on the building rendering. This simulation information may be provided to the renderers 240 for rendering visualizations of this shadow coverage. As another example, an operation simulator 264 may utilize the simulation engine 256 to simulate operations of the digital twin 210 into the future and provide information for the user interface 230 to display graphs of the simulated information. As one example, the operation simulator 264 may simulate the temperature of each zone of the digital twin 210 for 7 days into the future. The associated interface scene may then drive the user interface to construct and display a line graph from this data so that the user can view and interact with the results. Various additional application tools 260, methods for integrating their results into the user interface 230, and methods for enabling them to interact with the digital twin 210 will be apparent.

FIG. 3 illustrates an example digital twin 300 for construction by or use in various embodiments. The digital twin 300 may correspond, for example, to digital twin 120 or digital twin 210. As shown, the digital twin 300 includes a number of nodes 310, 311, 312, 313, 314, 315, 316, 320, 321, 322, 323 connected to each other via edges. As such, the digital twin 300 may be arranged as a graph, such as a neural network. In various alternative embodiments, other arrangements may be used. Further, while the digital twin 300 may reside in storage as a graph type data structure, it will be understood that various alternative data structures may be used for the storage of a digital twin 300 as described herein. The nodes 310-323 may correspond to various aspects of a building structure such as zones, walls, and doors. The edges between the nodes 310-323 may, then, represent relationships between the aspects represented by the nodes 310-323 such as, for example, adjacency for the purposes of heat transfer.

As shown, the digital twin 300 includes two nodes 310, 320 representing zones. A first zone node 310 is connected to four exterior wall nodes 311, 312, 313, 315; two door nodes 314, 316; and an interior wall node 317. A second zone node 320 is connected to three exterior wall nodes 321, 322, 323; a door node 316; and an interior wall node 317. The interior wall node 317 and door node 316 are connected to both zone nodes 310, 320, indicating that the corresponding structures divide the two zones. This digital twin 300 may thus correspond to a two-room structure, such as the one depicted by the building rendering 152 of FIG. 1.

It will be apparent that the example digital twin 300 may be, in some respects, a simplification. For example, the digital twin 300 may include additional nodes representing other aspects such as additional zones, windows, ceilings, foundations, roofs, or external forces such as the weather or a forecast thereof. It will also be apparent that in various embodiments the digital twin 300 may encompass alternative or additional systems such as controllable systems of equipment (e.g., HVAC systems).

According to various embodiments, the digital twin 300 is a heterogenous neural network. Typical neural networks are formed of multiple layers of neurons interconnected to each other, each starting with the same activation function. Through training, each neuron's activation function is weighted with learned coefficients such that, in concert, the neurons cooperate to perform a function. The example digital twin 300, on the other hand, may include a set of activation functions (shown as solid arrows) that are, even before any training or learning, differentiated from each other, i.e., heterogenous. In various embodiments, the activation functions may be assigned to the nodes 310-323 based on domain knowledge related to the system being modeled. For example, the activation functions may include appropriate heat transfer functions for simulating the propagation of heat through a physical environment (such as function describing the radiation of heat from or through a wall of particular material and dimensions to a zone of particular dimensions). As another example, activation functions may include functions for modeling the operation of an HVAC system at a mathematical level (e.g., modeling the flow of fluid through a hydronic heating system and the fluid's gathering and subsequent dissipation of heat energy). Such functions may be referred to as “behaviors” assigned to the nodes 310-323. In some embodiments, each of the activation functions may in fact include multiple separate functions; such an implementation may be useful when more than one aspect of a system may be modeled from node-to-node. For example, each of the activation functions may include a first activation function for modeling heat propagation and a second activation function for modeling humidity propagation. In some embodiments, these diverse activation functions along a single edge may be defined in opposite directions. For example, a heat propagation function may be defined from node 310 to node 311, while a humidity propagation function may be defined from node 311 to node 310. In some embodiments, the diversity of activation functions may differ from edge to edge. For example, one activation function may include only a heat propagation function, another activation function may include only a humidity propagation function, and yet another activation function may include both a heat propagation function and a humidity propagation function.

According to various embodiments, the digital twin 300 is an omnidirectional neural network. Typical neural networks are unidirectional-they include an input layer of neurons that activate one or more hidden layers of neurons, which then activate an output layer of neurons. In use, typical neural networks use a feed-forward algorithm where information only flows from input to output, and not in any other direction. Even in deep neural networks, where other paths including cycles may be used (as in a recurrent neural network), the paths through the neural network are defined and limited. The example digital twin 300, on the other hand, may include activation functions along both directions of each edge: the previously discussed “forward” activation functions (shown as solid arrows) as well as a set of “backward” activation functions (shown as dashed arrows).

In some embodiments, at least some of the backward activation functions may be defined in the same way as described for the forward activation functions-based on domain knowledge. For example, while physics-based functions can be used to model heat transfer from a surface (e.g., a wall) to a fluid volume (e.g., an HVAC zone), similar physics-based functions may be used to model heat transfer from the fluid volume to the surface. In some embodiments, some or all of the backward activation functions are derived using automatic differentiation techniques. Specifically, according to some embodiments, reverse mode automatic differentiation is used to compute the partial derivative of a forward activation function in the reverse direction. This partial derivative may then be used to traverse the graph in the opposite direction of that forward activation function. Thus, for example, while the forward activation function from node 311 to node 310 may be defined based on domain knowledge and allow traversal (e.g., state propagation as part of a simulation) from node 311 to node 310 in linear space, the reverse activation function may be defined as a partial derivative computed from that forward activation function and may allow traversal from node 310 to 311 in the derivative space. In this manner, traversal from any one node to any other node is enabled—for example, the graph may be traversed (e.g. state may be propagated) from node 312 to node 313, first through a forward activation function, through node 310, then through a backward activation function. By forming the digital twin as an omnidirectional neural network, its utility is greatly expanded; rather than being tuned for one particular task, it can be traversed in any direction to simulate different system behaviors of interest and may be “asked” many different questions.

According to various embodiments, the digital twin is an ontologically labeled neural network. In typical neural networks, individual neurons do not represent anything in particular; they simply form the mathematical sequence of functions that will be used (after training) to answer a particular question. Further, while in deep neural networks, neurons are grouped together to provide higher functionality (e.g. recurrent neural networks and convolutional neural networks), these groupings do not represent anything other than the specific functions they perform; i.e., they remain simply a sequence of operations to be performed.

The example digital twin 300, on the other hand, may ascribe meaning to each of the nodes 310-323 and edges therebetween by way of an ontology. For example, the ontology may define each of the concepts relevant to a particular system being modeled by the digital twin 300 such that each node or connection can be labeled according to its meaning, purpose, or role in the system. In some embodiments, the ontology may be specific to the application (e.g., including specific entries for each of the various HVAC equipment, sensors, and building structures to be modeled), while in others, the ontology may be generalized in some respects. For example, rather than defining specific equipment, the ontology may define generalized “actors” (e.g., the ontology may define producer, consumer, transformer, and other actors for ascribing to nodes) that operate on “quanta” (e.g., the ontology may define fluid, thermal, mechanical, and other quanta for propagation through the model) passing through the system. Additional aspects of the ontology may allow for definition of behaviors and properties for the actors and quanta that serve to account for the relevant specifics of the object or entity being modeled. For example, through the assignment of behaviors and properties, the functional difference between one “transport” actor and another “transport” actor can be captured.

The above techniques, alone or in combination, may enable a fully-featured and robust digital twin 300, suitable for many purposes including system simulation and control path finding. The digital twin 300 may be computable and trainable like a neural network, queryable like a database, introspectable like a semantic graph, and callable like an API.

As described above, the digital twin 300 may be traversed in any direction by application of activation functions along each edge. Thus, just like a typical feedforward neural network, information can be propagated from input node(s) to output node(s). The difference is that the input and output nodes may be specifically selected on the digital twin 300 based on the question being asked, and may differ from question to question. In some embodiments, the computation may occur iteratively over a sequence of timesteps to simulate over a period of time. For example, the digital twin 300 and activation functions may be set at a particular timestep (e.g., 1 minute), such that each propagation of state simulates the changes that occur over that period of time. Thus, to simulate longer period of time or point in time further in the future (e.g., one minute), the same computation may be performed until a number of timesteps equaling the period of time have been simulated (e.g., 60 one second time steps to simulate a full minute). The relevant state over time may be captured after each iteration to produce a value curve (e.g., the predicted temperature curve at node 310 over the course of a minute) or a single value may be read after the iteration is complete (e.g., the predicted temperature at node 310 after a minute has passed). The digital twin 300 may also be inferenceable by, for example, attaching additional nodes at particular locations such that they obtain information during computation that can then be read as output (or as an intermediate value as described below).

While the forward activation functions may be initially set based on domain knowledge, in some embodiments training data along with a training algorithm may be used to further tune the forward activation functions or the backward activation functions to better model the real world systems represented (e.g., to account for unanticipated deviations from the plans such as gaps in venting or variance in equipment efficiency) or adapt to changes in the real world system over time (e.g., to account for equipment degradation, replacement of equipment, remodeling, opening a window, etc.).

Training may occur before active deployment of the digital twin 300 (e.g., in a lab setting based on a generic training data set) or as a learning process when the digital twin 300 has been deployed for the system it will model. To create training data for active-deployment learning, a controller device (not shown) may observe the data made available from the real-world system being modeled (e.g., as may be provided by a sensor system deployed in the environment 110) and log this information as a ground truth for use in training examples. To train the digital twin 300, that controller may use any of various optimization or supervised learning techniques, such as a gradient descent algorithm that tunes coefficients associated with the forward activation functions or the backward activation functions. The training may occur from time to time, on a scheduled basis, after gathering of a set of new training data of a particular size, in response to determining that one or more nodes or the entire system is not performing adequately (e.g., an error associated with one or more nodes 310-323 passed a threshold or passes that threshold for a particular duration of time), in response to manual request from a user, or based on any other trigger. In this way, the digital twin 300 may be adapted to better adapt its operation to the real world operation of the systems it models, both initially and over the lifetime of its deployment, by tacking itself to the observed operation of those systems.

The digital twin 300 may be introspectable. That is, the state, behaviors, and properties of the 310-323 may be read by another program or a user. This functionality is facilitated by association of each node 310-323 to an aspect of the system being modeled. Unlike typical neural networks where, due to the fact that neurons don't represent anything particularly the internal values are largely meaningless (or perhaps exceedingly difficult or impossible to ascribe human meaning), the internal values of the nodes 310-323 can easily be interpreted. If an internal “temperature” property is read from node 310, it can be interpreted as the anticipated temperature of the system aspect associated with that node 310.

Through attachment of a semantic ontology, as described above, the introspectability can be extended to make the digital twin 300 queryable. That is, ontology can be used as a query language usable to specify what information is desired to be read from the digital twin 300. For example, a query may be constructed to “read all temperatures from zones having a volume larger than 200 square feet and an occupancy of at least 1.” A process for querying the digital twin 300 may then be able to locate all nodes 310-323 representing zones that have properties matching the volume and occupancy criteria, and then read out the temperature properties of each. The digital twin 300 may then additionally be callable like an API through such processes. With the ability to query and inference, canned transactions can be generated and made available to other processes that aren't designed to be familiar with the inner workings of the digital twin 300. For example, an “average zone temperature” API function could be defined and made available for other elements of the controller or even external devices to make use of. In some embodiments, further transformation of the data could be baked into such canned functions. For example, in some embodiments, the digital twin 300 itself may not itself keep track of a “comfort” value, which may defined using various approaches such as the Fanger thermal comfort model. Instead, e.g., a “zone comfort” API function may be defined that extracts the relevant properties (such as temperature and humidity) from a specified zone node, computes the comfort according to the desired equation, and provides the response to the calling process or entity.

It will be appreciated that the digital twin 300 is merely an example of a possible embodiment and that many variations may be employed. In some embodiments, the number and arrangements of the nodes 310-323 and edges therebetween may be different, either based on the device implementation or based on the system being modeled. For example, a controller deployed in one building may have a digital twin 300 organized one way to reflect that building and its systems while a controller deployed in a different building may have a digital twin 300 organized in an entirely different way because the building and its systems are different from the first building and therefore dictate a different model. Further, various embodiments of the techniques described herein may use alternative types of digital twins. For example, in some embodiments, the digital twin 300 may not be organized as a neural network and may, instead, be arranged as another type of model for one or more components of the environment 110. In some such embodiments, the digital twin 300 may be a database or other data structure that simply stores descriptions of the system aspects, environmental features, or devices being modeled, such that other software has access to data representative of the real world objects and entities, or their respective arrangements, as the software performs its functions.

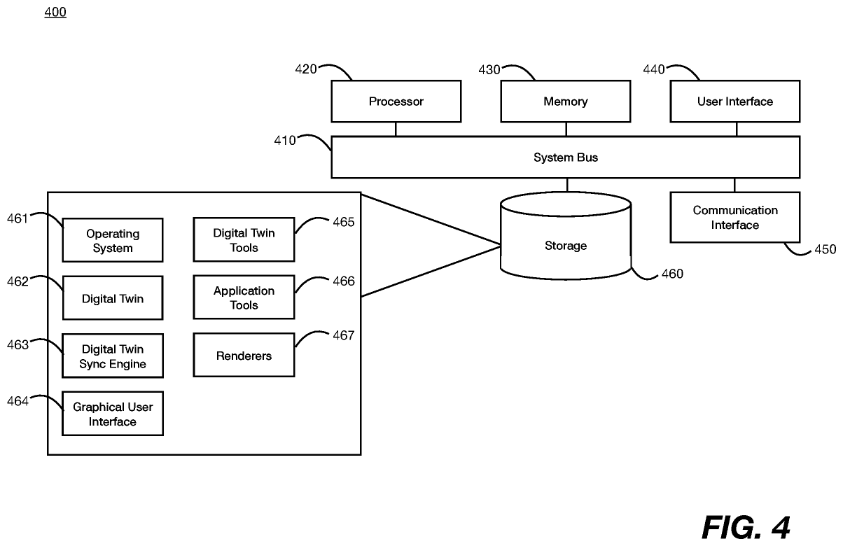

FIG. 4 illustrates an example hardware device 400 for implementing a digital twin application device. The hardware device 400 may describe the hardware architecture and some stored software of a device providing a digital twin application suite 130 or the digital twin application device 200. As shown, the device 400 includes a processor 420, memory 430, user interface 440, communication interface 450, and storage 460 interconnected via one or more system buses 410. It will be understood that FIG. 4 constitutes, in some respects, an abstraction and that the actual organization of the components of the device 400 may be more complex than illustrated.

The processor 420 may be any hardware device capable of executing instructions stored in memory 430 or storage 460 or otherwise processing data. As such, the processor 420 may include a microprocessor, field programmable gate array (FPGA), application-specific integrated circuit (ASIC), or other similar devices.

The memory 430 may include various memories such as, for example L1, L2, or L3 cache or system memory. As such, the memory 430 may include static random access memory (SRAM), dynamic RAM (DRAM), flash memory, read only memory (ROM), or other similar memory devices. It will be apparent that, in embodiments where the processor includes one or more ASICs (or other processing devices) that implement one or more of the functions described herein in hardware, the software described as corresponding to such functionality in other embodiments may be omitted.

The user interface 440 may include one or more devices for enabling communication with a user such as an administrator. For example, the user interface 440 may include a display, a mouse, a keyboard for receiving user commands, or a touchscreen. In some embodiments, the user interface 440 may include a command line interface or graphical user interface that may be presented to a remote terminal via the communication interface 450 (e.g., as a website served via a web server).

The communication interface 450 may include one or more devices for enabling communication with other hardware devices. For example, the communication interface 450 may include a network interface card (NIC) configured to communicate according to the Ethernet protocol. Additionally, the communication interface 450 may implement a TCP/IP stack for communication according to the TCP/IP protocols. Various alternative or additional hardware or configurations for the communication interface 450 will be apparent.

The storage 460 may include one or more machine-readable storage media such as read-only memory (ROM), random-access memory (RAM), magnetic disk storage media, optical storage media, flash-memory devices, or similar storage media. In various embodiments, the storage 460 may store instructions for execution by the processor 420 or data upon with the processor 420 may operate. For example, the storage 460 may store a base operating system 461 for controlling various basic operations of the hardware 400.

The storage 460 additionally includes a digital twin 462, such as a digital twin according to any of the embodiments described herein. As such, in various embodiments, the digital twin 462 includes a heterogeneous and omnidirectional neural network. A digital twin sync engine 463 may communicate with other devices via the communication interface 750 to maintain the local digital twin 462 in a synchronized state with digital twins maintained by such other devices. Graphical user interface instructions 464 may include instructions for rendering the various user interface elements for providing the user with access to various applications. As such, the GUI instructions 464 may correspond to one or more of the scene manager 232, UI tool library 234, component library 236, view manager 238, user interface 230, or portions thereof. Digital twin tools 465 may provide various functionality for modifying or utilizing the digital twin 462 and, as such, may correspond to the digital twin tools 250. Application tools 466 may include various libraries for performing functionality for interacting with the digital twin 462, such as computing advanced analytics from the digital twin 462 and performing simulations using the digital twin 462. As such, the application tools 466 may correspond to the application tools 260. The storage 460 may also include a collection of renderers 467 for rendering various aspects of the digital twin 462, its intended environment, information computed by the application tools 466, or other information for display to the user via the user interface 440. As such, the renderers 470 may correspond to the renderers 240 and may be responsible for rendering 2D or 3D visualizations such as the various renderings displayed via the various interface scenes described herein.

As described herein, the hardware implements a suite of applications such as a design application, site planning application, simulate application, analysis application, or other applications that may modify or otherwise utilize a digital twin. The various software components 464-467 (or specific instructions sets thereof) may cooperate to implement each of these applications. Some sets of instructions may be shared between two or more applications (e.g., instructions for rendering a digital twin from the renderers 467) while some sets of instructions may be uniquely used for a single application (e.g., instructions for simulating a light exposure value of the application tools 466).

While the hardware device 400 is shown as including one of each described component, the various components may be duplicated in various embodiments. For example, the processor 420 may include multiple microprocessors that are configured to independently execute the methods described herein or are configured to perform steps or subroutines of the methods described herein such that the multiple processors cooperate to achieve the functionality described herein, such as in the case where the device 400 participates in a distributed processing architecture with other devices which may be similar to device 400. Further, where the device 400 is implemented in a cloud computing system, the various hardware components may belong to separate physical systems. For example, the processor 420 may include a first processor in a first server and a second processor in a second server.

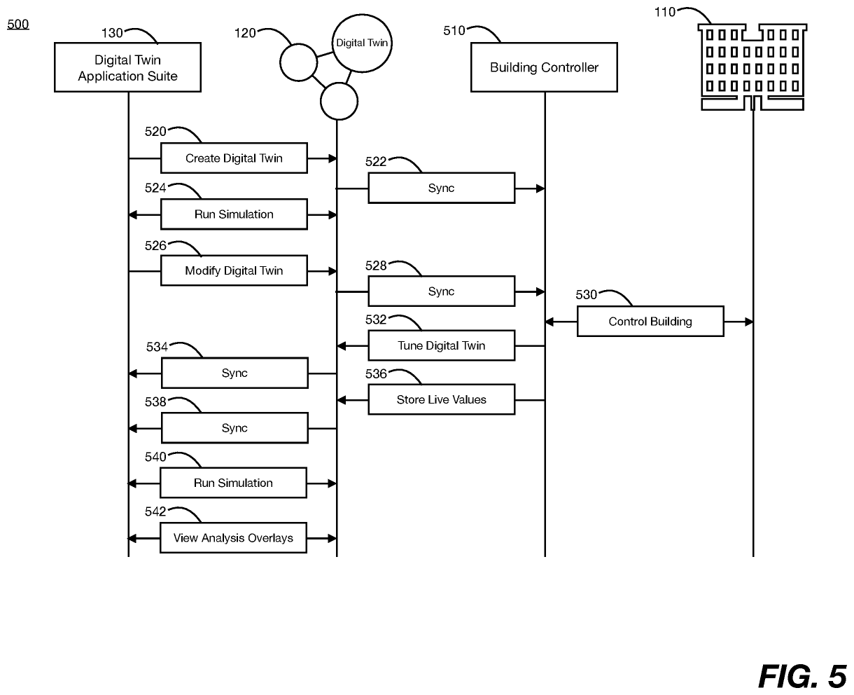

FIG. 5 illustrates an example sequence of operations 500 for creating and using a digital twin. It will be apparent that this sequence 500 is driven, at least in part, by user selection and that many other sequences may be followed for different user workflows and different participating devices and applications. According to this example, the digital twin application suite 130 and a building controller 510 both make use of the digital twin 120. The building controller 510 may be a building automation system (BAS), building management system (BMS) or any other device capable of controlling one or more systems of the building environment 110, such as a system of HVAC equipment. The controller 510 may also receive information from a sensor system disposed in the building environment to obtain a live view of aspects of the building environment 110, such as HVAC state (e.g., temperature, humidity, pressure, etc.).

While pictured as a separate entity with its own swimlane, it will be understood that the digital twin 120 may actually be stored in a memory of one or more devices, such as the digital twin application suite 130 and the building controller 510. As previously described, a distributed sync process (e.g, sync process 222) may ensure that any changes to a local copy of the digital twin 120 are propagated to any remote devices with copies of the digital twin 120, such that for the purposes of the present disclosure, that digital twin 120 may be viewed as a single, consistent entity that is available to multiple devices, even if those devices are remote from each other.

The sequence 500 begins with a user of the digital twin application suite 130 creating the digital twin 520, which then becomes the initial version of the digital twin 120. This operation 520 may be performed before the building environment 110 exists—in particular, the user may utilize the design application of the digital twin application suite 130 to create the design that will eventually be used to construct the building environment 110. In doing so, the digital twin 120 may be already created for use by the building controller 510 when the building environment 110 is eventually constructed. As another example, the creation operation 520 may be performed after the building environment 130 has been constructed. In such a context, the user may use the digital twin application suite 130 to initially match the existing construction of the building environment 110 for the purpose of planning renovations or for the specific purpose of creating the digital twin 120 for use in other contexts (e.g., by the building controller). Where the building environment 110 is already constructed and the building controller 510 is already installed, this initial digital twin 120 may be synced over to the building controller 510 (and any other devices interested in the digital twin 120, not shown). Through this sync operation 522, the digital twin application suite 130 transmits the digital twin 120 to the remote building controller device 510. It will be apparent that various methods may be employed for this transmission such as, for example, the application suite 130 explicitly sending the digital twin 120 to the building controller 510 directly or via one or more intermediate devices, the application suite 130 making the digital twin 120 available for pull by the building controller 510, or the application suite 130 sending the digital twin 120 to another server (not shown) that pushes updates to subscribing devices in such a way that digital twin application suite 130 need not even be aware of the existence of the building controller 510 or any other participating devices.

Next, the user of the digital twin application suite 130 uses the site planning application or the simulate application to run a simulation 524 of the building as currently designed in the digital twin 120. For example, the user may use the site planning application to simulate light exposure and shadow fall at different times of the year and, based on the simulation, may make decisions as to how to change the designed building. As another example, the user may use the simulate tool to simulate HVAC state of the building over a period of time with or without operation of the HVAC system (which also may be modeled by the digital twin 120 due to a user designing the HVAC system using the digital twin application suite 130 or another device, not shown; or due to the digital twin application suite 130 or another device, not shown, automatically generating an HVAC equipment system for the designed building). Again, based on the simulation output, the user may make decisions as to how to change the designed building.

Next, the user switches back to the design application to modify the digital twin 526 based on the decisions made by the user. For example the user may add, remove, move, or change the dimensions of rooms; change the layout of the building; change the materials used for the walls of the building (e.g., changing insulation); or make any other changes to the design. These changes are similarly synced 528 so that they are available to the building controller 510 (provided that the building 110 has been constructed and the building controller 510 has been installed, depending on the use case of the user).

Once operational, the building controller 510 leverages the digital twin 120 to control the building system(s) 530. This operation 530 may be continuous, repeatedly making control decisions and issuing control commands to the various devices installed in the building environment 110 throughout its lifetime. During this control operation 530, the building controller 510 may learn more about the building 110 or its changing conditions and use this information to modify the digital twin 120. For example, the building controller may determine that the digital twin 120 as previously created is not totally accurate to the observed operation of the building 110 and make adjustments, tuning the digital twin 532. In some embodiments, this may be accomplished by the building controller 510 gathering real observed data from the building 110 as training examples, and then performing a machine learning method (e.g., supervised learning with gradient descent) to tune parameters of the digital twin 120 such as coefficients or other parameters of the digital twin 120 activation functions such that the digital twin's simulations more closely match these training examples. These changes may then be synced 534 to the digital twin application suite 130.

As another example of modifications that the building controller 510 can make to the digital twin 120, the building controller 510 may place live values from the building 110 into the digital twin 120, such that a current building state is carried in the digital twin. For example, these live values may be live measurements that the building controller 510 reads from one or more sensor devices installed in the building. The building controller may then write these live measurements into an appropriate node of the digital twin 120 (e.g., a node representing that sensor or a node representing the zone in which the sensor is installed). In some embodiments, the building controller 510 may infer additional live measurements from those actually read from sensors by, for example, simulating the propagation of the live measurements through the digital twin 120 using its activation functions. As such, many nodes may have live measurements stored therein based on a relatively fewer number of sensors. The live values stored in the digital twin may encompass additional or alternative properties such as discrete values or Boolean values that represent information such as tracked inventory or objects (e.g., as may be obtained from RFID or other object tracking systems), occupancy numbers (e.g., as may be gathered from cameras and computer vision algorithms installed in various rooms), occupant information (e.g., as may be gathered from cell phones or other occupant identifiers), or condition/criteria statuses (e.g., as may be derived by comparing any live values or other available information to one or more pre-established rules evaluating to true/false or any other set of output values). After the controller 510 stores or updates live values in the digital twin 536, these modifications may also be synced back to the digital twin application suite 130.

Through various sync operations 534, 538 the digital twin application suite 130 receives the building controller's 510 (or other devices', not shown) updates to the digital twin 120. In this manner, the digital twin 120 carries information learned in the context of the different devices and applications back to the digital twin application suite 130 to drive those applications with the freshest and most accurate view of the building 110 modeled by the digital twin. Thus, the user may proceed to run additional simulations 540, such as those simulations described with respect to operation 524, but with the digital twin 120 as now tuned by the building controller 510. Thus, the simulation results from this later operation 540 may be more accurate or otherwise true to the real-world behavior of the building 110. The user may also at this point access the analysis application to view the informational overlays 542 provided therein. These overlays may visualize the various live values provided in the digital twin, including in some cases further interpolation or other processing of the live values for enhanced visualizations for presentation to the user. Thus, by enabling multiple devices and applications to modify, share, and utilize the digital twin natively, their respective functionalities are enhanced or, in some cases, enabled by the availability of the freshest and most accurate digital twin 120 for modeling the building environment 110.

### Design Application

Returning to FIG. 1, various embodiments of a design application will now be described. As noted above, the design application may provide the user with access to a number of drawing tools for creating and modifying a 2D or 3D representation of a building, other structure, or other object modeled by the digital twin 120. The design application may translate these drawing actions into representations forming at least part of the digital twin 120, such that the digital twin 120 may be used by other aspects of the digital twin application suite 130 or by other devices (not shown).

The workspace 150 includes an area where a user may view, explore, construct, or modify the building (or other entities or objects to be represented by the digital twin 120). As shown, the workspace 150 already displays a 3D rendering 152 of a building including at least a single floor and two rooms (labeled zone 1 and zone 2). Various controls (not shown) may be provided to the user for altering the user's view of the building rendering 152 within the workspace 150. For example, the user may be able to rotate, zoom, or pan the view of the building rendering 152 in one or more dimensions using mouse controls (click and drag, mouse wheel, etc.) or interface controls that can be selected. The user may also be provided with similar controls for altering the display of the building rendering, such as toggling between 2D and 3D views or changing the portion of the building that is rendered (e.g., rendering alternative or additional floors from a multi-floor building).

The tool panel 160 includes a number of buttons that provide access to a variety of interface tools for interacting with the workspace 150 or building rendering 152. For example, buttons may be provided for one or more of the previously-described interactions for changing the view of the building rendering 152. As another example, the tool panel 160 may provide buttons for accessing tools to modify the building rendering 152 itself. For example, tools may be accessible via the tool bar 160 for adding, deleting, or changing the dimensions of zones in the building rendering 152; adding, deleting, or changing structural features such as doors and windows; adding, deleting, or changing non-structural assets such as chairs and shelves; or for specifying properties of any of the foregoing.

The library panel 170 includes multiple expandable categories of items that may be dragged and dropped by the user into the workspace 150 for addition to the building rendering 152. Such items may be functional, such as various devices for sensing conditions of the building, providing lighting and ventilation, receiving system input from users, or providing output or other indicators to users. Other items may be purely aesthetic or may provide other information about the building (e.g., placement of shelves may help to determine an amount of shelf space). As before, placement of these items may indicate that these items are expected to be installed in the environment 110 or are already installed in the environment 110 so as to make the digital twin 120 aware of their presence.

While the foregoing examples speak of user tools for creating or making modifications to the building rendering 152, in various embodiments this functionality occurs by way of creation or modification of the digital twin 120. That is, when a user interacts with the workspace to create, e.g., a new zone, digital twin application suite 130 updates the digital twin 120 to include the new zone and new walls surrounding the zone, as well as any other appropriate modifications to other aspects of the digital twin (e.g., conversion of exterior walls to interior walls). Then, once the digital twin 120 is updated, the digital twin application suite 130 renders the currently displayed portion of the digital twin 120 into the building rendering 152, thereby visually reflecting the changes made by the user. Thus, not only does the building design application of the digital twin application suite 130 provide a computer aided design (CAD) tool, it simultaneously facilitates creation and modification of the digital twin 120 for use by other applications or to better inform the operation of the CAD functionality itself (e.g., by providing immediate feedback on structural feasibility at the time of design or by providing generative design functionality to automatically create various structures which may be based on user-provided constraints or preferences).

The exploration panel 180 provides a tree view of the digital twin to enable the user to see a more complete view of the digital twin or to enable easy navigation. For example, if the full digital twin is a multi-story building, the exploration panel 180 may provide access to all floors and zones, where the workspace is only capable of displaying a limited number of floors at the level of detail desired by the user.

The project information panel 190 provides the user with interface elements for defining properties of the build or project to which the building is associated. For example, the user may be able to define a project name, a building type, a year of construction, and various notes about the project. This meta-data may be useful for the user in managing a portfolio of such projects. The project information panel 190 may also allow the user to specify the location of the building. Such information may be used by other applications such as site planning (e.g., to digitally recreate the real world environment where the building is located or will be built) or simulation (e.g., to simulate the typical weather and sun exposure for the building). Various other applications for the digital twin application suite 130 will be described below as appropriate to illustrate the techniques disclosed herein.

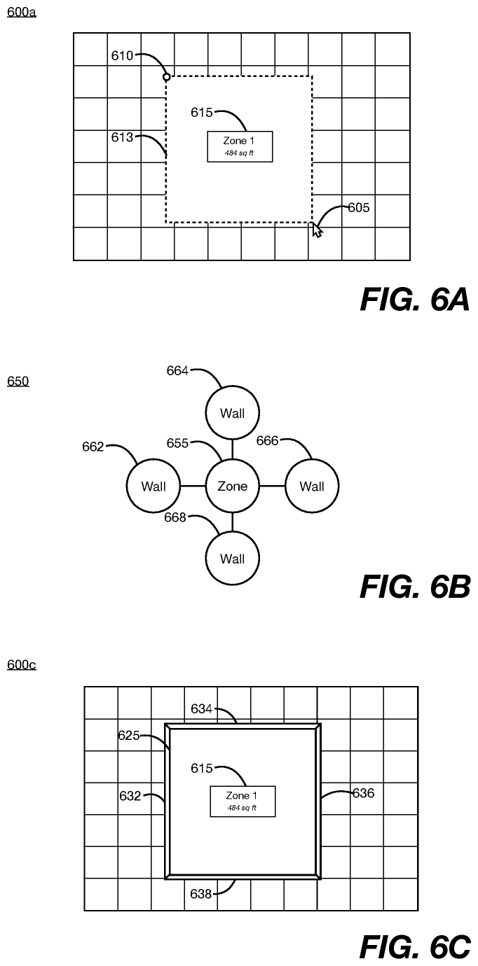

FIG. 6A illustrates a first example workspace 600a illustrating a drawing tool. The workspace 600a may be presented as part of a design application and, as such, may be presented in place of workspace 150 in a user interface scene corresponding to the design application. The user's cursor 605 is currently operating according to a selected zone drawing tool. As shown, the user has clicked an initial corner point 610 within the workspace 600a and dragged the cursor 605 to a new point. A visualization of a new zone boundary 613 is shown in dotted line to show the boundaries of the new zone that will be committed if the user were to unclick at the current point. Thus, as the user moves the cursor 605, the dimensions of the boundary 613 may change to ensure that the initial point 610 and current cursor 605 position are located at opposite corners of the box. Similarly, a label 615 may show a name of the new zone (e.g., an automatically generated label or a label previously provided by the user) along with a parameter such as the scaled area of the current boundary 613 (here shown as 484 square feet). This parameter may also continually update as the user moves the position of the cursor 605 to indicate the new scaled area (or other property) associated with the current boundary dimensions 605. Upon letting go of the mouse button (or other action appropriate to the form of user input), the user may indicate a desire to commit the current drawing to the digital twin.

FIG. 6B illustrates an example digital twin 650 translated from drawing tool input. This digital twin 650 may correspond to the digital twin 120, 210 and may be generated as a result of the zone drawing tool described with respect to FIG. 6A. As the user commits the drawing tool input, the digital twin application suite translates the input to a digital twin. For example, the digital twin application suite may first create a zone node 655 matching the zone drawn by the user. For example, the zone may include an area property or length and width properties capturing the drawn dimensions of the zone. The zone node 655 may include additional properties based on various defaults or project settings. For example, the zone node 655 may also include a height based on a standard room height or a room height previously set for the current project or the current floor of the project.

Next, the digital twin application may determine that by default, a zone should be surrounded by four wall nodes (e.g., by applying a heuristic rule to the creation of a new zone). Thus, the digital twin application suite may also generate four new wall nodes 662, 664, 666, 668 and connect them each to the zone node 655. The wall nodes 662-668 may similarly be provided with initial properties based on previous user input or default information. For example, the wall construction may be assumed to be a standard construction of studs and drywall, and properties may be set in the wall nodes 662-668 corresponding to such (e.g., an R value for heat transfer purposes). The digital twin application suite may also establish activation functions between the various connected nodes 655-668. As explained, these activation functions may be based on applicable physics-based functions (e.g., functions describing the transfer of heat from wall-to-zone or vice-versa) or may be computed using reverse mode auto-differentiation. Thus, the creation of the digital twin is at least partially generative, with the digital twin application suite generating structure of inclusion in the digital twin without user input explicitly indicating the presence of these structures.

It will be understood that this digital twin 650 may be only a portion of a larger digital twin digital twin 120, 210 modeling a full building of multiple zones; a system of controllable equipment; or other structures, devices, systems, or entities relevant to the context at hand. For example, the nodes 655-668 may be connected to additional digital twin nodes (not shown) representing these other aspects of the context. Thus, the term “digital twin” should be understood to refer to a full digital twin as well as smaller but still functional snippets thereof (such as the pictured digital twin 650 even when included in a larger digital twin representing a full building).

FIG. 6C illustrates a second example workspace 600c illustrating a rendering of a digital twin, such as the digital twin 650 generated based on the user's zone drawing tool input. The workspace 600c may correspond to a later state of the workspace 600a, after the digital twin 650 has been created in response to the user input. As shown, the digital twin application suite has rendered a graphical representation of the zone area 625 based on the zone node 655 based on at least some of the properties held in that node 655 (e.g., location, length, and width). Similarly, the digital twin application suite has rendered graphical representations of the walls 632, 634, 636, 638 based on the wall nodes 662, 664, 666, 668, respectively. Again, the rendering may be based, at least in part, on properties stored in the wall nodes 662, 664, 666, 668 (e.g., endpoints and thickness). Thus, the rendering is driven by the digital twin 650, rather than being a pure drawing resulting directly from the drawing tool input from the user.

While shown as a 2D floorplan, it will be apparent that the rendering of workspace 600c may take on different forms. For example, the structure may be rendered as a 3D isometric or perspective rendering. As another example, the rendering may include additional features such as doors, windows, devices (e.g., sensors or thermostats). Further, the rendering may be shown together with other rooms on the same floor, with other floors, or as part of a full building represented by the digital twin 120. In some embodiments, the user may determine how the digital twin is rendered via a collection of UI components (not shown) that may allow, e.g., switching between 2D and 3D renderings or changing the portion of the digital twin 120 that is currently rendered.

With the rendered digital twin displayed, the workspace 600c or other unpictured interface may allow for further drawing or modification of the digital twin by the user. For example, the user may be able to click and drag the rendered zone 625 to change the location within the workspace, leading to corresponding changes to the nodes 655-668 of the digital twin 650. Similarly, the user may use another drawing tool to resize the rendered zone 625 by clicking and dragging a corner, again leading to corresponding changes to the nodes 655-668 of the digital twin 650. In some embodiments, clicking a rendered element may provide a detailed view for the underlying node 655-668, enabling the user to directly modify additional parameters. For example, upon clicking the left wall 632, the exploration panel 180 may update its contents to show various parameters held by the wall node 662, some of which may be editable. A width slider may be so-presented, enabling the user to alter the thickness of the wall. Upon changing the thickness, the property of the wall node 662 may be correspondingly updated, which may then drive the rendered graphical representation of the wall 332 to be thicker or thinner, depending on the adjustment direction. Various additional properties for such modification will be apparent.

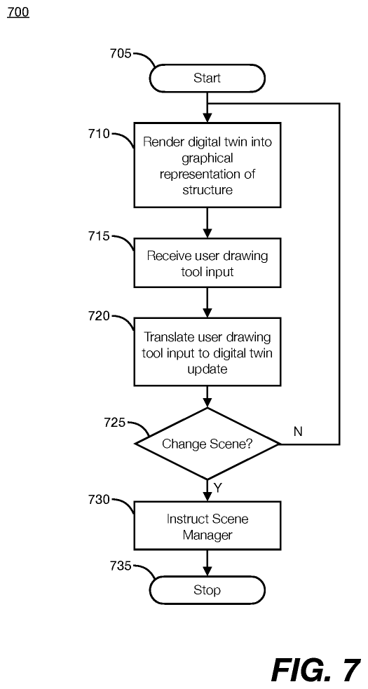

FIG. 7 illustrates an example method 700 for implementing a design application main loop. The method 700 may correspond to a subset of the application tool instructions 466 where the application tools 466 provide a main loop for the applications implemented therein. In other embodiments, applications may be implemented as a collection of federated components operating without any main loop. For example, various functionalities independently implemented in the graphical user interface instructions 464, digital twin tools 465, application tools 466, and renderers 467 may come together to realize a design application. In such embodiments, the method 700 may not correspond to literal implemented instructions, but rather may be descriptive of an example user path through the various connected sets of instructions (e.g., a “trace” through multiple sets of instructions for a particular program flow). Thus, the method 700 may in some respects be a simplification, and additional or alternative steps or step arrangements may be implemented.

The method 700 may begin in step 705 in response to, for example, the user switching to the design application or the design application otherwise being loaded/displayed by the digital twin application suite. In step 710, the digital twin application suite renders the digital twin 120 into a graphical representation of the structure it represents. In a context where no digital twin has been created yet, step 710 may be skipped or otherwise result in no rendering for display to the user.

Next, in step 715, the digital twin application suite receives input from a user drawing tool. For example, the user may provide input using a zone drawing tool as described with respect to FIGS. 6A-C, including information such as a location and zone dimensions. As another example, the user may provide input using a move tool, translating a previously-created zone from one location to another. Further drawing tool examples may include placement of windows, doors, devices, or objects; addition or deletion of floors; alterations to various properties such as structure material or visual characteristics; etc. Through the use of these intuitive drawing tools, the user is thus able to provide their specification of various physical structures to be modeled by a digital twin.

In step 720, the digital twin application suite translates the user input into a digital twin update that is committed to the digital twin. This may be implemented by attaching code to each drawing tool of the UI tools 234 specifying how input from that tool translates to digital twin changes. For example, the zone drawing tool may include a script or other code specifying the creation of a zone node and then four attached walls (or another number of walls if the zone drawing tool is able to enable the user to draw other shapes). As another example, the move tool may include a script or other code specifying that the location of the zone and any attached walls should be updated based on the input and a rule that any immediately adjacent and parallel wall nodes should be joined into a single interior wall node. Various additional scripts or other code for implementing translations from drawing input to digital twin updates will be apparent. Thus, based on the input in step 715, the digital twin is updated and can then be rendered with the changes on subsequent executions of the rendering step 710.

In step 725, the digital twin application suite determines whether the user or other trigger has called for a change to another UI scene, such as a selection of a different application by the user. If not, the method 700 loops back to step 710 to continue rendering the digital twin and enabling further user drawing and consequent updates to the digital twin. When the scene is to be changed, the method 700 proceeds to step 730 where the scene manager is instructed to change the scene to the one that has been requested (e.g., a switch to the site planning application, simulate application, or analysis application). The method 700 then proceeds to end in step 735.

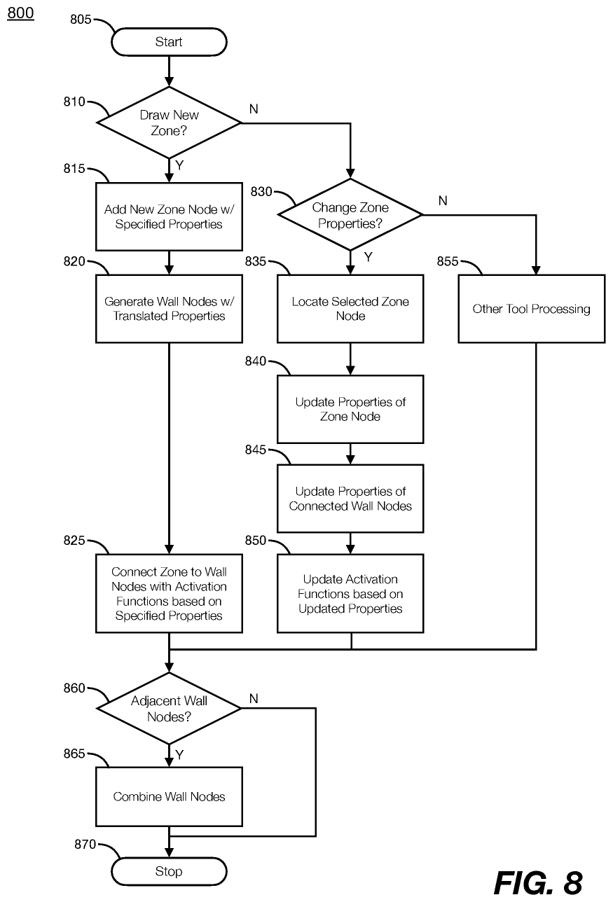

FIG. 8 illustrates an example method 800 for translating user drawing input into a digital twin update. The method 800 may correspond to step 720 (or a portion thereof) of method 700 and, as such, may correspond to one or more of the graphical user interface instructions 464, digital twin tools 465, application tools 466, and renderers 467 coming together to realize the translation step of a design application. In some embodiments, the method 800 may not correspond to literal implemented instructions, but rather may be descriptive of an example user path through the various connected sets of instructions (e.g., a “trace” through multiple sets of instructions for a particular program flow). Thus, the method 800 may in some respects be a simplification, and additional or alternative steps or step arrangements may be implemented.

The method 800 begins in step 805, for example in response to method 700 proceeding to step 720 or otherwise in response to receiving user drawing tool input. The method proceeds to step 810 where the path will branch based on which drawing tool the user utilized to provide the received input. As noted above, in some embodiments, the script or other code for implementing the translation may already be attached to the tool and, as such, these determination steps 810, 830 may be omitted in favor of, e.g., steps 815-825 being implemented in the association with a zone drawing tool, steps 835-850 being implemented in association with a zone modification tool, and so forth.

In step 810, the digital twin application suite determines whether the input is from a zone drawing tool or otherwise indicates that a new zone has been drawn. If so, the method proceeds to step 815 where the digital twin application suite creates a new zone node with any specified properties that can be attributed to the zone node. These properties may include properties carried by the user input (e.g., location, width, height); properties imputed from the project/floor/other context of the drawing (e.g., floor height); or default properties (e.g., the zone is filled with air). If there is already a digital twin for the current project, the node is added to that digital twin; otherwise, the node will form the first node of the digital twin for the project and will be built out from there.

Next, in step 820, the digital twin application suite generates wall nodes that are implied by the drawing received from the user. For example, if the drawing tool provided a rectangle zone area, four walls may be implied. In some embodiments the drawing tool is able to input zones of other shapes such as regular polygons with different numbers of edges or arbitrary polygons drawn by the user point-by-point. In this step 820, the digital twin application suite will in most contexts create a number of wall nodes equal to the number of edges on the drawn zone. Each wall node may also be provided with properties which may be carried by the user input, imputed from context, or based on default. In some cases, properties may be translated from those specified by the user. For example, where the user input specifies a point location and height and width of the zone, this information may be used to mathematically derive a location and orientation or two endpoints for each wall node, such that the wall nodes are “positioned” to surround the defined zone, and to join each other near the vertices of the zone perimeter. Similarly, the surface area of each wall may be derived from the zone's room height and the length property of each wall node.

In step 825, the digital twin application suite connects the new zone node to each of the new wall nodes within the digital twin. The digital twin application suite also establishes activation functions along these new edges. The activation functions may be based on known physics functions such a convective heat transfer function, which may take into account properties of the nodes, such as the wall's surface area. The activation functions may also be derived in some directions using reverse-mode auto-differentiation, as previously described. In any event, the digital twin is provided with a set of functions suitable for simulating the propagation of state through the digital twin. Where the digital twin is formed according to alternative embodiments that use data arrangements other than neural networks, there may not be activation functions present, but in some such embodiments a similar set of functions suitable for performing relevant simulations are nonetheless provided in the digital twin at this step.

If, in step 810, it is instead determined that the user input is not indicative of a new zone, the method 800 proceeds to step 830 where the digital twin application suite determines whether the user input instead indicates a change to an existing zone's properties. For example, the user may have selected a rendering of a wall or an intersection between two wall renderings, and moved the selected component to change the dimensions of the zone. As additional examples, the user may have clicked and dragged the zone to change its location or selected the rendering of the zone and then changed a property using a user interface control (e.g., a control presented via the exploration panel 180). If the user input indicates a change to zone properties, the method proceeds to step 835 where the digital twin application suite first locates the zone node in the digital twin 120 to which the user input applies. This may be accomplished, for example, by including a node identifier attached to the selectable rendering of that zone that, when the zone rendering is clicked by the user, is captured and used to identify the correct zone.

In step 840, the digital twin application suite updates the properties of the impacted zone node based on the changes communicated or implied by the user input. Then, in step 845, the connected wall nodes are similarly updated based on the changes communicated or implied by the user input, including translations from zone-to-wall properties as previously described with respect to step 820. Then, in step 850, if the property changes necessitate any changes to the activation functions, the activation functions may be updated with appropriate changes. In some embodiments, the activation functions are driven by the properties such that simply changing the property of a wall node (e.g., its surface area) also changes the function that will be used for simulation (e.g., because it is expressed in a way that is agnostic to the actual surface area until the time of function computation, when the surface area property value at that time will be used).

As noted, the design application may provide numerous tools for enabling user interaction with the rendering of the digital twin. For example, tools may be provided to move walls, move wall vertices, change zone height, add floors, change wall thickness, add columns, etc. If the tool input is not one that changes zone properties, the method pay proceed to step 855 where other steps may be performed to identify the type of input and appropriate changes to the digital twin.

In some embodiments, the method 805 may apply one or more rules to the results of all drawing tools or to a subset of drawing tools. For example, various modifications to zones or walls may result in combining two walls. Accordingly, in step 860, the digital twin application suite determines whether any walls are now positioned for merger. This may be determined, for example, by identifying whether any wall nodes are substantially parallel to each other and are coincident or sufficiently close to each other. If so, the two wall nodes may be combined into a single wall node (representing a single wall between two zones) in step 865. In some cases, the combination of two wall nodes may be trivial-simply replacing the two wall nodes with a single wall node while preserving the connections to other nodes from the two wall nodes. In some cases, the combination may be more complex. For example, the properties of the new wall node may be different from the properties of the two wall nodes. This may be seen, e.g., where two exterior walls node are combined into one interior wall node—the typical construction of exterior and interior wall nodes differ from each other and, as such, properties such as the R value of the new interior wall node may be recomputed. As another example, the two wall nodes may overlap only partially, such as where one wall node is 10 feet, while the other is 5 feet. In such cases, the overlapping portions of the wall nodes may be combined into a single wall node, while the remaining portion(s) of the non-overlapping wall may be translated into new wall nodes as well. Thus, a 10 foot exterior wall and a 5 foot exterior wall may be combined into a 5 foot interior wall (the wall node representing the overlap portion) and a 5 foot exterior wall (the wall node representing the portion of the 10 foot wall that extends past the 5 foot wall). The method 800 then proceeds to end in step 870.

### Site Planning Application

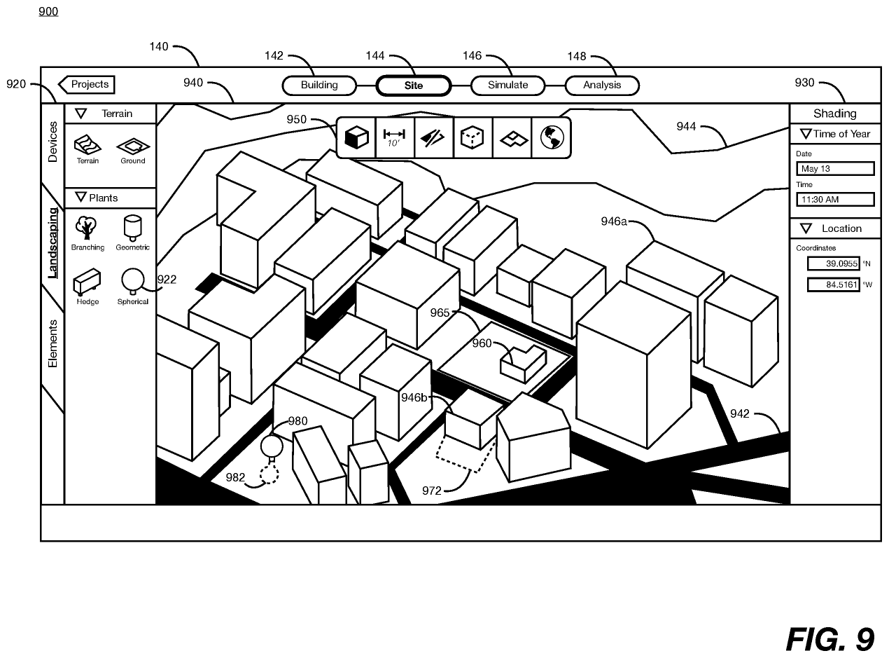

FIG. 9 illustrates an example user interface scene 900 for providing a site planning application. This user interface scene 900 may be presented by the digital twin application suite 130, e.g., in response to a user requesting access to the site planning application by selecting the Site button 144. According, the Site button 144 includes a visual indication of present application; here, the Site button 144 is shown in bold form, though other indicators are possible.

The interface scene 900 includes a library panel 920, which may be similar to library panel 170. As such, the library panel 920 may include multiple expandable categories of items that may be dragged and dropped by the user into the workspace 940 for addition to the site rendering 152. In the present view, the library panel 920 shows a landscaping library, rather than a devices library. As such, the library panel 920 includes a terrain category with tools for shaping terrain and a plants category with various plants that may be placed in the site rendering.

The exploration panel 930 has been updated to include controls relevant to the particular application (or sub-application) being utilized by the user. In particular, the user may have requested access to a shading sub-application of the site planner application for simulating light exposure at different times of year for the building represented by the digital twin 120. As such, the exploration panel 930 includes controls for specifying a time of year, a time of day, and a location. This information may be useful for determining the location of the sun relative to the site rendering, which may be useful for simulating light exposure and shadows. Thus, the site planning application may be referred to as a simulation application.

The workspace 940 includes a rendering of the digital twin in the context of a location with surrounding geometry. As shown, the rendering includes a road map rendering 942, terrain rendering 944, and surrounding building renderings 946a,b.

The road map rendering 942 may include graphical, satellite, or other representations of road in the area being displayed. This information may be obtained from various sources such as an open map or satellite data database accessible via an API. Further, the road map rendering 942 may include additional or alternative information from the roads displayed. For example, the road map rendering 942 may include representations of rivers, trees, and other natural features; or the tops of various buildings and other structures, as may be gathered by satellite imaging. To begin the rendering process, the obtained road map data may be applied as a texture to a plane or 3D mesh object initially in a planar configuration.

The terrain rendering 944 may convey elevation or other terrain data, which may be obtained from various sources such as an open elevation database accessible via an API. This data may then be used to deform the plane to which the map data was applied as a texture, thereby modifying the displayed map to appear, in a 3D view, to follow the terrain contours of the real site being recreated.

The surrounding building renderings 946a,b may convey information about the geometry of the structures at the site. Various methods may be used to identify building geometries from available data such as image recognition methods to identify rooftops or elevations from satellite data; obtaining available elevation data from an external source; or obtaining information from other digital twins created for some or all of the other buildings (e.g., by querying respective controllers installed in or otherwise associated with those buildings). Once the surrounding building shapes are identified, various approaches workspace 940 scene 900 such as, for example, rendering discrete objects in the shape of the buildings or in the shape of primitives (e.g., simple boxes); or by extruding the ground plane in the location of the surrounding buildings 946a,b upward to the presumed height of each building. Similar approaches may be used to account for other surrounding 3D geometry such as trees and other landscaping, structures such as bridges, or anything else that may be useful for the purposes of the application associated with the workspace 940.

The workspace 940 also includes a collection of buttons 950 associated with UI tools, linked to other interface scenes, or that otherwise provide the user with the to interact with the renderings 942, 944, 946a,b or other aspects of the workspace 940. Example tools to make available are a button for accessing a tool for performing measurements of the rendered environment; a button for adding or removing geometry from one or more of the renderings or aspects thereof; a button for returning to an interface scene providing location picker map; or a button to initiate placement (or re-placement) of a building in the environment. Various additional interface elements (not shown) may also be provided for other interactions, such as changing (panning, zooming, rotating) the view of the renderings 942, 944, 946a,b or for initiating other functionality such as a shadow/sun exposure simulation.

The workspace 940 additionally includes a rendering of a subject building 960 together with a footprint 965. The subject building rendering 960 may be one or more buildings that the user has indicated a desire to view in the context of the rendered site. For example, the subject building rendering may be a rendering of the digital twin 120 (and, as such, may correspond to a building previously designed by the user using the design application). The footprint 965 may be a portion of the site rendering 942, 944, 946a,b that has been prepared for placement of the subject building rendering 960. In particular, 3D geometry such as terrain 944 and building renderings 946a,b overlapping the footprint may be removed or flattened to provide a portion of the ground plane on which the subject building rendering 960 may be virtually placed. In some embodiments, this procedure may be automatic, while in others, the terrain may be manually prepared by the user (e.g., by using a ground preparation tool accessible via the library panel 920).

As previously noted, the current scene 900 may present a light exposure/shadow simulation. In particular, ray-casting or other lighting techniques may be used to determine the shadows that would be cast by the various renderings 944, 94a,b, 960 at different times of year. Various approaches may be used to accomplish this simulation. For example, a position of the sun relative to the rendering may be determines for a particular location, date, and time of day. The sun position may then be treated as a light source for virtually illuminating the rendering and casting shadows. For example, as shown, one of the buildings 946b is shown to cast a shadow 972. Similarly, a rendering of a tree 980 (e.g., as may have been placed in the workspace 940 by a user dragging and dropping a tree 922 from the library panel 920 or by using another tool) may also cast a shadow 982 using the same ray-casting or lighting techniques. It will be apparent that while two shadows 972, 982 are illustrated, that numerous additional shadows may be rendered across the entire workspace 940 rendering based on simulated shadows cast by entities such as, e.g., terrain 944, other buildings 946a, the subject building 960, or other objects rendered in the scene. Further, where the user adjusts the date, location, or time (e.g., by using the shading exploration panel 930 or using another UI tool, not shown), the shadows 972, 982 may be updated based on the new position of the virtual sun. Similarly, if the sun automatically moves (e.g., where the rendering simulates the passage of time as an animation), the shadows 972, 982 may be updated based on the new position(s) of the virtual sun.

This shadow simulation may be useful in various manners. As a first use, the user may leverage the shadow simulation to predict sun exposure of the building 960 under design and make modifications to achieve a desired sun exposure. According to one use case, the user may determine that it is undesirable for sunlight to pass through a window of the building 960 and hit a particular wall (e.g., a wall where a television is likely to be installed). When the simulation shows this undesired result, the user may make various changes to remedy such as changing the location of the building 960, changing the position or orientation of the building 960 within the footprint 965, adding trees or other landscaping to the footprint 965, or returning to the design application to make modifications to the building 960 itself. Various other use cases will be apparent.

Another use for the shadow simulation may be for use in simulations of HVAC needs. In this case, as an additional or alternative feature to rendering shadows 972, 982 for visualization, the simulation may create a sun exposure metric for storing the simulated sun exposure of the building 960 at different dates and times. This information may be used to inform an HVAC simulation (e.g. a simulation accessible via the simulate application) to better assess HVAC needs or performance as sun exposure will have an impact of the heat naturally experienced by the building-a building with more sun exposure may tend to naturally heat up more during the day, whereas a building experiencing more shade may not naturally heat up as much.

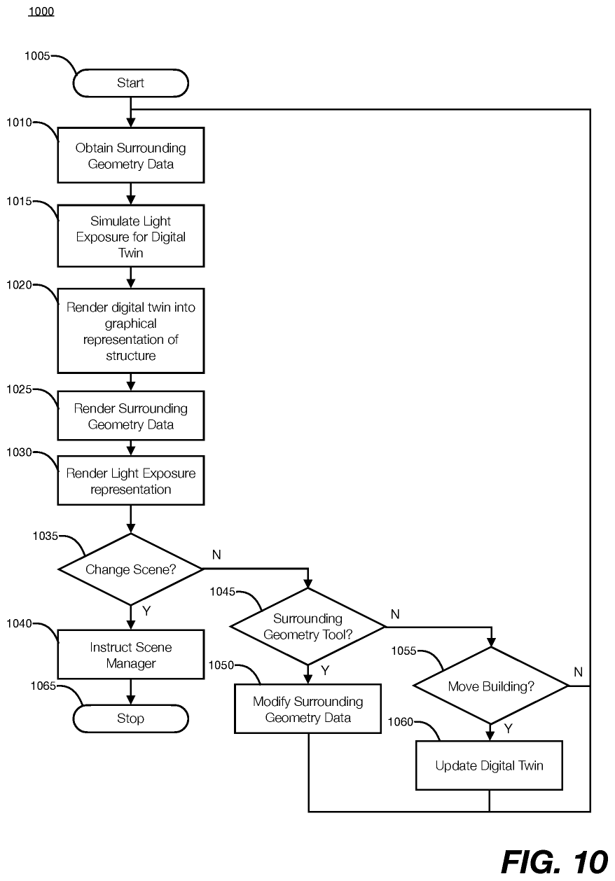

FIG. 10 illustrates an example method 1000 for implementing a site planner application main loop. The method 1000 may correspond to a subset of the application tool instructions 466 where the application tools 466 provide a main loop for the applications implemented therein. In other embodiments, applications may be implemented as a collection of federated components operating without any main loop. For example, various functionalities independently implemented in the graphical user interface instructions 464, digital twin tools 465, application tools 466, and renderers 467 may come together to realize a site planner application. In such embodiments, the method 1000 may not correspond to literal implemented instructions, but rather may be descriptive of an example user path through the various connected sets of instructions (e.g., a “trace” through multiple sets of instructions for a particular program flow). Thus, the method 1000 may in some respects be a simplification, and additional or alternative steps or step arrangements may be implemented.

The method 1000 may begin in step 1005 in response to, for example, the user switching to the site planner application or the site planner application otherwise being loaded/displayed by the digital twin application suite. In step 1010, the digital twin application suite obtains surrounding geometry data for the site. For example, this step may involve querying one or more open databases for map data, terrain data, or other data descriptive of a real-world location, such as a location stored in the digital twin 120 or project metadata associated therewith. In some embodiments, the surrounding geometry data may be generated locally, at least in part. For example, the digital twin application suite may perform object recognition in satellite image data or may use elevation data to identify one or more surrounding buildings and generate 3D objects to represent those buildings in renderings and simulations.

In step 1015, the digital twin application suite simulates light exposure data for the digital twin or the surrounding geometry data. In various embodiments, this is accomplished using a raycasting technique. To generate one or more measures of sun exposure, one or more rays are cast from a virtual location of the digital twin (e.g., a center point or an outer surface) toward a virtual location of the sun (e.g., as determined by a date, time, and location being simulated) to determine whether the ray intersects with any objects such as the surrounding geometry data. If so, the origin point of the ray may be considered to be in shadow. This information may then be used for other simulations or other procedures. For the purposes of rendering shadows for display to the user, this process may be repeated for multiple points in the virtual environment. Alternatively, other techniques such as raycasting (i.e., casting multiple rays from the camera to the virtual scene and reflecting them toward the sun to determine occlusion data) or OpenGL lighting techniques may be used for rendering shadows.

The digital twin application suite may then render the digital twin, the surrounding geometry data, and the light exposure representation (e.g., shadows) in steps 1020, 1025, 1030, respectively. It will be apparent that, depending on the context and the rendering approaches used, the steps 1020, 1025, 1030 may not be discrete or ordered steps; instead, these geometries and visualizations may be rendered all together, in a different order, or in an interleaved manner. In some embodiments where the shadow simulation output is a rendering of shadows in the context of the site rendering, the rendering process for the light exposure representation step 1030 itself may constitute a simulation and step 1015 may be omitted. In other words, the step of raycasting, ray tracing, or other lighting techniques may be performed at the time of rendering 1030.

Having rendered the scene, the method 1000 proceeds to handle any user input by, first, checking in step 1035 whether the user or another trigger has requested to change the scene, e.g., to a scene associated with a different tool. If so, the method 1000 proceeds to step 1040 where the scene manager is instructed to change the scene to the one that has been requested (e.g., a switch to the design application, simulate application, or analysis application). The method 1000 then proceeds to end in step 1065.

If, on the other hand, the scene is not to be changed, then the loop of method 1000 is to continue for at least another cycle. The method 1000 proceeds from step 1035 to step 1035, where digital twin application suite determines whether user input has been received from a surrounding geometry tool. For example, the user may have used a terrain tool to raise, lower, flatten, or otherwise change the terrain of the area, or the user may have added landscaping such as trees or shrubs to the site rendering. If the user has specified additional geometry data in this or other manners, the method 1000 proceeds to step 1050 where the digital twin application suite uses this additional geometry data to modify the surrounding geometry data. This may involve a change to the surrounding geometry data (e.g., a change to terrain data or existing trees) or an addition of new data entirely (e.g., addition of new trees). The method 1000 then loops back to step 1010 where the rendering can be updated based on the modified surrounding geometry data (now including the additional geometry data received via the tool).

If, on the other hand, the user has not provided any additional surrounding geometry data, the method instead proceeds to step 1055 where the digital twin application suite determines whether the user has indicated that the building should be moved. The user may be provided with tools to move or rotate the building within its footprint, to move the footprint to a new spot within the rendered environment, or to choose an entirely different location (e.g. a new city) for placement of the building and its footprint. Each of these changes may have implications for the rendering and light exposure simulation. In step 1060, the digital twin application suite makes appropriate modifications to the digital twin (or project metadata, simulation parameters, or surrounding geometry, depending on the implementation) and the method 1000 loops back to step 1010 so that the changes can be taken into account for rendering and simulation purposes. It will be apparent that various additional UI tools may be provided to the user for making other changes to the digital twin, the environment, or simulation. Thus, while the step 1055 may be shown looping back to step 1010 with no changes if the building has not been moved, various additional steps (not shown) may be included for processing such other changes before looping back to step 1010.

### Simulate Application

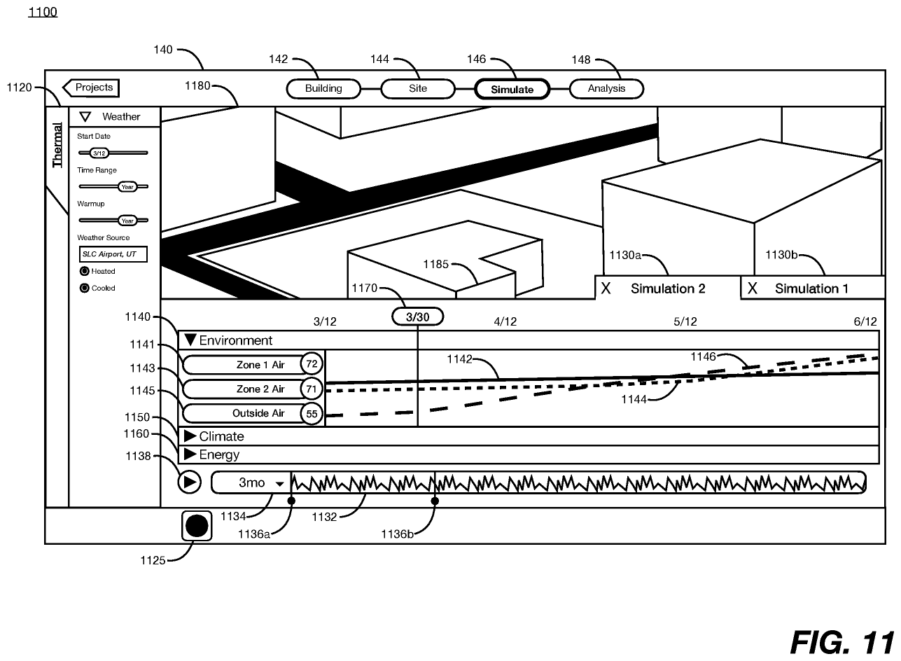

FIG. 11 illustrates an example user interface scene 1100 for providing a simulate application. This user interface scene 1100 may be presented by the digital twin application suite 130, e.g., in response to a user requesting access to the simulate application by selecting the Simulate button 146. According, the Simulate button 146 includes a visual indication of present application; here, the Simulate button 146 is shown in bold form, though other indicators are possible.

The interface scene 1100 includes a library panel 1120, which may be similar to library panel 170. As such, the library panel 1120 may include at least expandable category for interacting with the simulate application. In the present view, the library panel 1120 shows a set of configurable parameters for a weather simulation. Using this view of the library panel 1120, the user may set parameter for a weather simulation such as a start date for simulation, a time range for simulation, a period for simulated system warmup, a weather source, and selectors for indicating whether a heating or cooling system of equipment should be included as part of the simulation. In various embodiments, panels for selecting and configuring other simulations may also be provided via the library panel 1120.

The interface scene 1100 also includes a simulate button 1125 enabling the user to indicate that a simulation should be performed. Upon selection of the simulate button 1125 by the user, the digital twin application suite 130 may begin to perform a simulation as currently configured in the library panel 1120. Various approaches for performing various simulations will be apparent. In the context of HVAC simulation or other digital twin based simulations, the digital twin application suite 130 may propagate state (e.g., heat energy) through a heterogenous neural network over a series of timesteps, recording the state in nodes of interest at each step for playback to the user. In some embodiments, such a simulation may take an amount of time to complete that will be noticeable to the user; in such embodiments a loading bar may be displayed (e.g., in place of the pictured simulation timeline 1132) while simulation progresses.

Upon completion of a requested simulation, the resulting simulation data may be presented to the user via the interface scene 1100 for exploration. As shown, each completed simulation's data may be accessed via a simulation tab 1130a,b corresponding to the respective simulation. Upon clicking one of the tabs 1130a,b, the data for the associated simulation may be loaded into the interface. An overall simulation timeline 1132 is presented to visualize the simulated data for the user. A drop down selector 1134 enables the user to select various time frames from which detailed data will be displayed from the simulation (e.g., 1 week, 3 months, full simulated time frame). As shown, the selector indicates a 3 month time frame, corresponding to the time window indicator with left and right bounds 1136a,b, respectively. At present, these window bounds 1136a,b correspond to a window from March 12 (the start date of the simulation) and June 12 (3 months later). This corresponds to the range of data shown in the detailed data chart 1140. In various embodiments, the user may be able to reposition the windows between the bounds 1136a,b along the simulation timeline 1132, thereby changing the beginning and end dates of this 3 month window, thereby updating the data displayed in the detailed data chart 1140. In some embodiments, the user may be able to reposition the bounds 1136a,b independently of each other, thereby changing the width of the window (e.g., to less than or greater than three months), with a corresponding update to the range of data shown in the detailed data chart 1140. A play button 1138 may enable the user to indicate that the selected portion of the data should be “played out” as an animation on the user interface scene 1100.

One or more collapsible detailed data charts 1140, 1150, 1160 may provide the user a view of the simulated data for the current window of the simulation. As shown, an environment detailed data chart 1140 is expanded and may show simulated information such as air temperature, radiant temperature, or humidity of various zones, objects, or other sources within the digital twin. A collapsed climate detailed data chart 1150 may, when expanded, show simulated information such as sun position, light exposure, cloud cover, weather temperatures, and weather humidity. A collapsed energy detailed data chart 1160 may, when expanded, show simulated information such as heating load, cooling load, and lighting load. It will be appreciated that alternative or additional types of data may be shown for various simulations. For example, a detailed data chart for lighting may also be included (not shown) for displaying simulated information such as a measure of daylight and artificial light received for one or more zones in the digital twin.

Turning back to the environment detailed data chart 1140, three data points are shown as being tracked (though more or fewer data points may be simulated and shown in other contexts): a zone 1 air temperature 1141, a zone 2 air temperature 1143, and an outside air temperature 1145. A shuttle 1170 indicates a current time for which a snapshot of values is shown in the data points 1141, 1143, 1145. Thus, as shown, the current simulation shows a zone 1 air temperature 1141 of 72 degrees on March 30. The zone 2 air temperature 11433 is simulated to be 71 degrees and an outside air temperature 1145 is simulated to be 55 degrees on the same date. It will be apparent that this view may be in some respects a simplification; for example, while a single value is shown for the day where the shuttle is positioned 1170, at least one of these data points 1141, 1143, 1145 is likely to fluctuate throughout the day. In some embodiments, the data points 1141, 1143, 1145 may be a daily average (e.g., the simulation may produce daily averages to begin with, or more granular simulated data may be averaged for the purposes of presentation on the interface scene 1100.) In some embodiments, more granular data may be shown, and the shuttle 1170 may be positionable at specific simulated times of day to access this more specific data.

The environment detailed data chart 1140 also includes a line chart with three chart lines 1142, 1144, 1146 corresponding to the same simulated values as the data points 1141, 1143, 1145, respectively. These chart lines 1142, 1144, 1146 illustrate to the user the simulated data for these three datapoints 1141, 1143, 1145 over the currently selected three-month window. Thus, while the user can see that on March 30 (per the shuttle 1170) Zone 1 and Zone 2 are simulated to maintain comfortable temperatures, the chart lines 1144, 1146 show that as the outside temperature rises in May and June, the temperature of Zone 2 may rise considerably, indicating additionally cooling need in that zone. In some embodiments, the user may be able to click and drag the shuttle 1170 to explore other days, updating the values in data points 1141, 1143, 1145 to reflect the simulated data for the newly-selected day. In some embodiments, the data points 1141, 1143, 1145 may be presented in a different order on different days, such that the values are ordered top-down from highest to lowest. For example, if the user moves the shuttle 1170 to an area around May 31, the environment details data chart 1140 may order the data points 1141, 1143, 1145 with the outside air data point 1145 on top, the zone two air data point 1143 in the middle, and the zone one air data point 1141 on the bottom (reflecting the order of the lines 1142, 1144, 1146 in this area of the chart).

A workspace 1180 may additionally one or more renderings relevant to the simulation such as a rendering of the digital twin 120 into a building 1185 in the context of the surrounding geometry set out in the site planner application. In some embodiments, one or more of the data points 1141, 1143, 1145 (or other datapoint) may be visualized in the workspace as, for example, a colored or gradient overlay on a rendering of the building floorplan to show the relative temperatures. In some embodiments, surrounding aspects such as shadow cover, cloud cover, weather events, etc. may also be rendered in the workspace when they appear in the simulated data.

As noted above, where the user presses the play simulation button 1125, the interface scene 1100 may play out an animation of the simulation. This may involve the shuttle 1170 advancing automatically through the dates at some predetermined rate. As the shuttle 1170 advances, other aspects of the interface scene 110 may automatically update as described. For example, the data points 1141, 1143, 1145 may automatically update and reorder (if appropriate) with each advance of the shuttle 1170. Similarly, the renderings 1185 in the workspace 1180 may similar update to show changes in weather, shadows, clouds, informational overlays, etc. as the shuttle advances 1170.

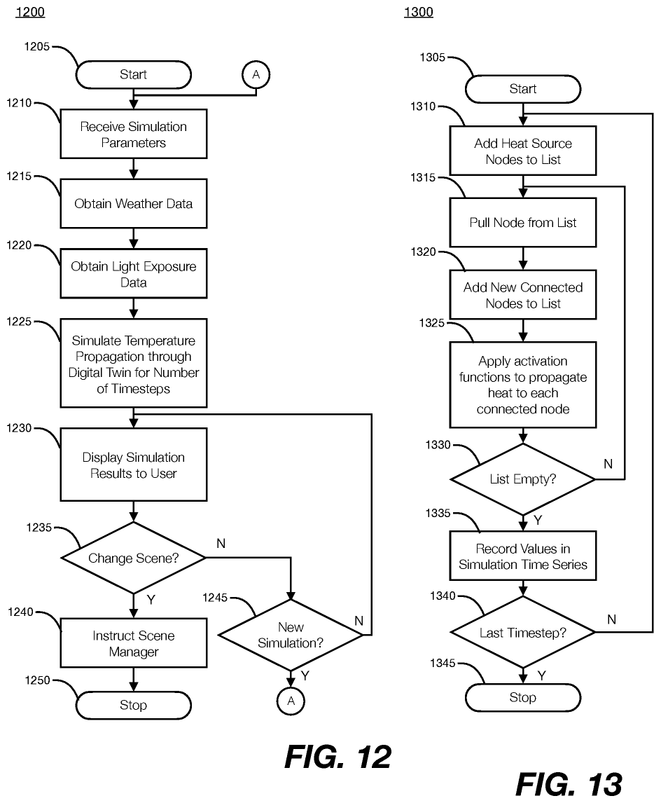

FIG. 12 illustrates an example method 1200 for implementing simulate application main loop. The method 1200 may correspond to a subset of the application tool instructions 466 where the application tools 466 provide a main loop for the applications implemented therein. In other embodiments, applications may be implemented as a collection of federated components operating without any main loop. For example, various functionalities independently implemented in the graphical user interface instructions 464, digital twin tools 465, application tools 466, and renderers 467 may come together to realize a simulate application. In such embodiments, the method 1200 may not correspond to literal implemented instructions, but rather may be descriptive of an example user path through the various connected sets of instructions (e.g., a “trace” through multiple sets of instructions for a particular program flow). Thus, the method 1200 may in some respects be a simplification, and additional or alternative steps or step arrangements may be implemented. Further, while the method 1200 may be described in the context of HVAC simulations or other simulations that take weather data into account, various modifications for adapting the method 1200 for performing other simulations will be apparent.

The method 1200 begins in step 1205 in response to, for example, the user switching to the simulate application or the simulate application otherwise being loaded/displayed by the digital twin application suite. The method 1200 proceeds to step 1210 where the digital twin application suite receives one or more parameters for running a simulation. These parameters may be user specified (e.g., via the library panel 1120), carried by the digital twin or project metadata (e.g., a location of the building to be simulated), based on default values, or obtained from other sources. For example, in the context of a heating or other HVAC simulation, the parameters may include a time period to be simulated, a date for simulation, or a weather data source. According to various embodiments, the weather data source may be identified by, for example user selection of a particular source (e.g., from a list or drop-down selection); user identification of a location and subsequently automatic identification of a weather source for the location; a digital twin project metadata identifying a location and subsequent automatic identification of a weather source for the location; or other method for identifying a source of weather data for use in simulating weather at a particular location.

In step 1215, the digital twin application suite obtains weather data from the identified weather data source for use in performing the simulation. According to various embodiments, the weather data may include live weather data, historic weather data for different times of year, forecast weather data for the future, or simulated weather data generated to match the typical climate of the current location for the digital twin. The use of simulated weather data may be particularly beneficial because multiple varying sets of weather data may be generated for a particular location, such that the simulation may be rerun with slightly varying but still foreseeable weather conditions to identify nuances in the operation of the building under different possible weather patterns. In step 1220, the digital twin application suite obtains light exposure data for use in the simulation as well. The light exposure data may be, for example, one or more a time series values generated be a light exposure simulation (such as the light exposure simulation described above with respect to the site planning application). Such light exposure data may provide additional simulation accuracy by taking into account the sun's impact on the heat of the building throughout the day or year.

Having gathered basis parameters and data, the digital twin application suite then performs the simulation in step 1225, producing one or more time series of simulated data. Then, in step 1230, the digital twin application suite displays the gathered data to the user, such as in the interactive form described with respect to the user interface scene 1100. Having performed the simulation and presented it to the user, the digital twin application suite then moves on to process possible user input. In step 1235, the digital twin application suite determines whether the user or other trigger has called for a change to another UI scene, such as a selection of a different application by the user. When the scene is to be changed, the method 1200 proceeds to step 1240 where the scene manager is instructed to change the scene to the one that has been requested (e.g., a switch to the design application, site planning application, or analysis application). The method 1200 then proceeds to end in step 1250.

If, on the other hand, the scene is not to be changed, the method 1200 proceeds from step 1235 to step 1245 where the digital twin application suite determines whether user input indicates that a new simulation is to be performed. If so, the method loops back to step 1210 to perform the new simulation and present the resulting data to the user. Otherwise, the method 1200 loops back to step 1230 where the user interface scene will simply provide further interactivity with the previously run simulation. It will be apparent that additional steps may be included to process other user input that may be received via the user interface scene.

FIG. 13 illustrates an example method 1300 for performing a simulation. The method 1300 may correspond to step 1225 of method 1200 and may correspond to one or more of the application tools 466 utilizing the libraries of the digital twin tools 465 to perform the requested simulation. Further, while the method 1300 may be described in the context of HVAC simulations or other simulations involving the propagation of heat through a digital twin model, various modifications for adapting the method 1300 for performing other simulations will be apparent.

The method 1300 begins in step 1305, for example in response to method 1200 proceeding to step 1225 or otherwise in response to some application request to perform a simulation. In step 1310, the digital twin application suite initializes a list of digital twin nodes to process by, for example, adding each node that serves as a thermal energy source to the list. As will be understood, while the term “heat source” is used here, nodes that inject cold air or otherwise lower thermal energy in the building may also be included in the list, so as to take into account all temperature-impacting nodes. For example, a weather node and a sun exposure node (both of which may be connected in the digital twin to exterior wall nodes and include appropriate activation functions for translating weather and light exposure to thermal energy) may be located and added to the list. Such a weather node and sun exposure node may be driven in the simulation by the weather data and light exposure data obtained in steps 1215 and 1220, respectively, of FIG. 12. In some embodiments, such as those where the digital twin includes a model of an HVAC equipment system, the nodes corresponding to the HVAC equipment that impact the thermal energy of the building (e.g. by adding hot or cool air) may also be added to the list.

In step 1315, the digital twin application suite identifies a next node from the list for processing. Next, in step 1320, the digital twin application suite identifies each node connected to the current node, and adds these to the list (if not already processed or present in the list) so that they, too, can be processed as part of the simulation. In step 1325, the digital twin application suite propagates state (e.g., thermal energy) from the current node to adjacent nodes. This step may involve applying the activation function for each edge between the current node and each adjacent node, respectively. As previously noted, these activation functions may be at least initially based on physics-based functions modeling the propagation of heat energy from one medium to the next and may take into account properties of the current node and the adjacent node such as current heat energy, dimensions, or R values. In some embodiments, the activation functions may have been further tuned by, for example, a learning process implemented in a controller or other device receiving real measurements from the building modeled by the digital twin.

As an example, consider the digital twin of FIG. 3 with an additional node representing the impact of weather (which, as described, may be driven by weather data obtained from a weather data source) having a connection and associated activation function to each exterior wall node 311, 312, 313, 315, 321, 322, 323. The weather nodes may have a current temperature of 75 degrees which is to be propagated to each exterior wall node 311-313, 315, 321-323 (and, from there, to the other nodes). Exterior wall node 311 may have a current temperature of 65 degrees. An activation function (modeling the transfer of heat energy between the outside air and the exterior wall represented by the exterior wall node 311) may propagate thermal energy to the exterior wall node 311 and determine that the exterior wall node 311 temperature should raise to 68 degrees on this timestep. Meanwhile, the next exterior wall node 312 may also have a current temperature of 65 degrees. Another activation function from the weather node may propagate thermal energy to the exterior wall node 312 and determine that the exterior wall node 312 temperature should raise to 72 degrees on this timestep. Thus, while the two described exterior wall nodes 311, 312 may begin at the same temperature, they may end the time step with different temperatures. This may be due to various reasons such as, for example, a difference in the dimensions of the real world exterior walls modeled by these two nodes 311, 312 with exterior wall node 312 having a relatively larger surface area for more heat transfer or the digital twin having learned the real world wall modeled by that node 312 tends to heat up faster (e.g., due better air movement adjacent that wall). These two nodes 311, 312 may, in later iterations of step propagate their heat (or thermal energy) to the zone node 310 according to additional activation functions, which may then update its own internal temperature based on the received thermal energy from those nodes 311, 312 and others propagating thermal energy into the node 310.

It will be apparent that, the digital twin 300 presents a somewhat 2-dimensional view of the modeled building and that this example simulation is also in terms of two-dimensional state propagation. Such an approach may be sufficient in many applications, whereas other applications may utilize a 3-dimensional model of the building. For example, the digital twin 300 may include ceiling, floor, or roof nodes to represent structures and thermal energy sources above and below the floorplan modeled by the digital twin 300 as pictured. For example, thermal energy from a zone node (not shown) in a higher floor may be propagated to an intermediate floor/ceiling node (not shown), which may in turn be propagated to the zone nodes 310, 320, thereby providing a more accurate simulation of the real world physics that are being modeled.

Next, in step 1330, the method 1300 determines whether the node list is empty or if additional nodes remain to be processed for this timestep. If additional nodes remain to be processed, the method 1300 loops back to step 1320 to process the next node in the list. Otherwise, the method 1300 proceeds to step 1335 where the digital twin application suite records the simulated data for later presentation to the user. For example, for each data series to be shown to the user as simulation output (e.g., the data points 1141, 1143, 1145 presented via the user interface scene 1100) may be read from the digital twin 120 and stored in a time series that will be iteratively constructed through multiple executions of the step 1335 for each timestep of the simulation. Next, in step 1340, the digital twin application suite determines whether the simulation is complete or if additional timesteps remain to be processed before the end of the desired simulation time period is reached. If additional timesteps remain to be simulated, the method 1300 loops back to step 1310 to propagate state for the next time step. Otherwise, the method proceeds to end in step 1345 and the recorded simulation values constructed in step 1335 may be used by the requesting method (e.g., method 1200).

### Analysis Application

Generally, an analysis application may provide one or more live views of data stored in the digital twin 120. As previously described, this data may be data collected directly from the building environment 110 modeled by the digital twin 120 (e.g., gathered by a controller, stored in the digital twin, and synced back to the digital twin application suite 130). As such, the analysis application may also be seen as providing live views of the building environment 110 state such as, for example, heat maps, inventory tracking, or occupant mapping. In some embodiments, the analysis application may be an operational building information model, integrating information about the building construction with live information about the building's operation.

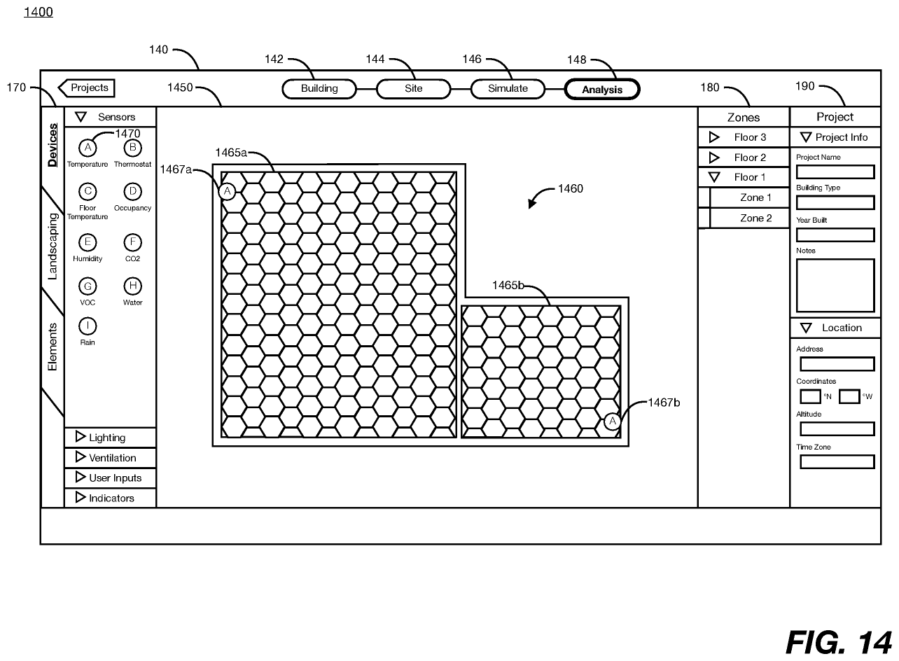

FIG. 14 illustrates an example user interface scene 1400 for providing a simulate application. This user interface scene 1400 may be presented by the digital twin application suite 130, e.g., in response to a user requesting access to the analysis application by selecting the Analysis button 148. According, the Simulate button 146 includes a visual indication of present application; here, the Analysis button 148 is shown in bold form, though other indicators are possible.

The interface scene 1400 includes many of the same panels 140, 170, 180, 190 described with respect to the interface scene described in connection with digital twin application suite 130, though other panels may be displayed instead. A workspace 1450 includes a rendering 1460 of the digital twin 120, similar to those previously described with respect to rendering 152. Thus, the rendering 1460 may take various forms, such as a 2D floorplan, a 3D single floor view, a 2D multi-floorplan view, or a 3D multi-floor view. As previously-described, the rendering 1450 may be a rendering of the digital twin and, as such, driven by the digital twin 120 as a model of a real world environment. Further, the user may be provided with one or more controls for changing the view of the rendering 1460 such as pan, zoom, and rotate view tools.

The rendering 1460 includes one or more overlays 1465a,b for communicating live values to the user. These overlays 1465a,b will be described with relation to communicating live temperature values; various modifications for overlaying other live values on the digital twin rendering 1460 will be apparent. As shown, the overlays 1465a,b show a hexagonal grid across the zones of the digital twin 120. Each hexagon may be colored according to a legend for communicating a live temperature value or a temperature value derived therefrom in the area of that hexagon. For example, 60 degrees may be a shade of blue, 70 degrees may be a shade of green, and 80 degrees may be a shade of red, with a gradient of colors representing temperature values therebetween. Various other overlays for communicating this or similar information will be apparent such as, for example, a continuous color gradient across the zone renderings, rather than the hexagon grid as pictured.

The data used to drive the overlay visualizations 1465a,b may be live values carried by the digital twin after being read and stored in the digital twin 120 by another device (e.g., a controller device receiving measurements from a sensor system deployed in the building environment 110). In some embodiments, these live values are stored in the various nodes of the digital twin, such that a temperature may be read directly from a zone node or wall node to determine the live temperature value associated with the corresponding real world structure. In some embodiments, the digital twin 120 additionally includes nodes representing the sensor devices themselves; in such embodiments, the live values from such sensors may be stored in the sensor nodes and then used to drive the overlay renderings 1465a,b.

It will be understood that in many embodiments, a true live measurement may not be obtainable for each point to be visualized (e.g., each hexagon of the two overlay renderings 1465) because sensors may not be individually deployed for each such point. Instead, it is more likely that each zone may only have one or two sensors relevant to a particular overlay rendering 1465a,b. In such embodiments, the live values may be used to derive additional values for rendering more granular information. For example, to derive the additional values that will drive the colors of the overlay 1465b, multiple live values carried by the digital twin 120 may be used to interpolate additional values for the various locations across the area of the associated zone. For example, where the rendering 1460 is driven by the digital twin 300, temperature values may be read from the zone node 320, interior wall node 317, and exterior wall nodes 321-323; and, based on the relative positions of each of the entities in the digital twin, used to interpolate a temperature values across the area defined in the zone node 320.

Such an interpolation process may be further enhanced by ascribing a particular location to the temperature value of the zone node 320, rather than it representing a temperature of the zone “at large.” According to some embodiments, the position of the zone node's 320 temperature value may be determined based on a position of the sensor that actually created the live value attributed to the zone node 320. Thus, in some such embodiments, the digital twin 120 includes information about sensor locations, such as additional digital twin nodes representing the installed sensors. This information may be obtained in various manners such as, for example, the user dragging and dropping a sensor object 1470 from the library panel 170 into the workspace to one or more specific locations 1467a,b, to update the digital twin 120 with a new node representing the sensor. This may be accomplished in some embodiments in the user interface scene 1400 for the analysis application or in other scenes or applications (e.g. in the design application). In some embodiments, this sensor node may be linked to the real world sensor deceive such that live values reported thereby are added by the controller to that sensor node. For example, the controller or another device may perform a commissioning procedure that verifies the operation of the real world sensor and links it to the appropriate digital twin 120 sensor node based on its real world location or other criteria. Thereafter, as the digital twin application suite receives live values carried by the digital twin 120, the live value captured by the sensors can be attributed to particular locations 1467a,b and then additional values for driving the coloring of the overlay renderings 1465a,b can be better interpolated. As an alternative approach, the digital twin 120 may be further leveraged for the interpolation process. In particular, the zone nodes 310, 320 may be broken into multiple connected zones nodes, representing subdivisions of the physical space represented by the zone. For example, one zone node may be created for each hexagon in the hexagon grids of the overlay renderings 1465a,b. In some embodiments, the zone nodes 310,320 may be broken across the 2-dimensional floorplan so that values can be interpolated across the floorplan area; in some embodiments, the zone nodes 310,320 may be broken across the 3-dimensional space so that values can be interpolated across the zone's full volume in all dimensions. Connections may then also be created between each such adjacent node along with activation functions modeling the free flow of air and thermal energy though a space (or, in some embodiments, modeling the specific air currents of the physical zones represented by the zone nodes). Thereafter, propagation of state through the subdivided zone nodes (e.g., in a manner similar to that described in relation to the simulation method 1300) may achieve an interpolation of values across the area (or volume) of the physical zone for purposes of the overlay renderings 1465a,b.

The user interface scene 1400 may enable additional interactions with the analysis. For example, the user may be provided with buttons or interface controls to access analysis visualization other than the heat analysis overlays 1465a,b pictured. In some embodiments, the exploration panel 180 may provide controls for adjusting the parameters of the overlay renderings 1465a,b such as colors to be used, range of temperatures to be visualized, or form of interpolation to be used. In some embodiments, the visualizations 1465a,b may animate with updates to the visualized temperatures (or other visualized live values such as inventory or occupant locations), as the controller or other device responsible for reading sensor values in the building environment 110 continues to sync new, fresh data back to the digital twin application suite.

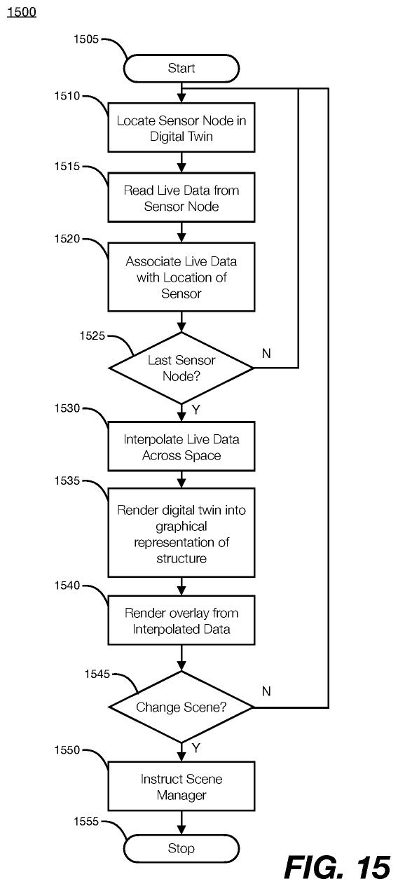

FIG. 15 illustrates an example method 1500 for implementing an analysis application main loop. The method 1500 may correspond to a subset of the application tool instructions 466 where the application tools 466 provide a main loop for the applications implemented therein. In other embodiments, applications may be implemented as a collection of federated components operating without any main loop. For example, various functionalities independently implemented in the graphical user interface instructions 464, digital twin tools 465, application tools 466, and renderers 467 may come together to realize an analysis application. In such embodiments, the method 1500 may not correspond to literal implemented instructions, but rather may be descriptive of an example user path through the various connected sets of instructions (e.g., a “trace” through multiple sets of instructions for a particular program flow). Thus, the method 1500 may in some respects be a simplification, and additional or alternative steps or step arrangements may be implemented. Further, while the method 1500 may be described in the context of HVAC visualization or other visualization of live heat information into account, various modifications for adapting the method 1500 for presenting other live visualization will be apparent.

The method 1500 begins in step 1505 in response to, for example, the user switching to the analysis application or the analysis application otherwise being loaded/displayed by the digital twin application suite. The digital twin application suite then begins to gather live values for visualization by, in step 1510, locating a sensor node in the digital twin from which a live value may be retrieved in step 1515. In step 1520, the live value is associated with the location of the sensor (e.g., an x-y or x-y-z point, as may be stored in the properties of the sensor node) for the purposes of the visualization. In step 1525, the digital twin application suite determines whether additional sensor nodes remain in the digital twin from which to extract live values. If so, the method loops back to step 1510 to continue extracting all relevant live values. It will also be apparent that in various embodiments live values may be stored in additional or alternative nodes to sensor nodes. For example, zone nodes and wall nodes may also carry live values. Modifications to the method 1500 to additionally capture these live values and associate them with locations in the visualization will be apparent.

Once the live values have been pulled from the digital twin 120, the method 1500 proceeds to step 1530 where the digital twin application suite interpolates these live values across the space for visualization. As noted above, various approaches may be employed for interpolation including, for example, traditional mathematical interpolation such as linear interpolation or leveraging the operation of digital twin 120 in a similar manner to the simulation method 1300 to propagate state across multiple subdivided zones. Interpolation may be performed individually for each zone, or may be performed across all zones (e.g., such that live values in one zone may still impact the derivation of values in another nearby zone). Once the relevant live and derived values have been obtained, the method 1500 proceeds to step 1535, where the digital twin application suite renders the digital twin into a graphical representation of the structure, in a manner similar to those previously discussed. Then, in step 1540, the digital twin application suite renders the overlays from the live and derived data, so as to visualize the data of interest for the user.

Having rendered the visualization, the method 1500 proceeds to step 1545 where the digital twin application suite determines whether the user or other trigger has called for a change to another UI scene, such as a selection of a different application by the user. If not, the method 1500 loops back to step 1510 where the digital twin application suite will update the visualization if there has been an update to the digital twin in the background including fresh live values (e.g., by operation of the sync process 222). In this manner, the renderings of steps 1535,1540 may continually update and animate based on the freshest live and derived data, providing a live visualization. When the scene is to be changed, on the other hand, the method 1500 proceeds to step 1550 where the scene manager is instructed to change the scene to the one that has been requested (e.g., a switch to the design application, site planning application, or simulate application). The method 1500 then proceeds to end in step 1555.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain example aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the scope of the claims.

We claim:

1. A method for providing a live visualization, the method comprising:
receiving, via a first user interface scene, a user specification of a physical structure;
committing a data representation of the physical structure to a digital twin;
transmitting the digital twin to a remote device;
receiving an update to the digital twin from the remote device, producing an updated digital twin; and
rendering, via a second user interface scene, a graphical representation of the updated digital twin.

2. The method of claim 1, wherein:
the update comprises at least one live value from a real-world environment represented by the digital twin, and
the graphical representation comprises a graphical representation of the at least one live value.

3. The method of claim 2, wherein the at least one live value comprises at least one live measurement, the method further comprising:
using the at least one live measurement to interpolate measurement values across the physical structure,
wherein the graphical representation comprises a graphical overlay representing the measurement values across the physical structure.

4. The method of claim 3, further comprising receiving a user specification of a measurement device location relative to the physical structure;
wherein using the at least one live measurement to interpolate measurement values across the physical structure comprises associating a measurement of the at least one live measurement with the device location.

5. The method of claim 1, wherein:
the digital twin comprises a set of functions modeling a behavior associated with the physical structure;
the update comprises a modification of at least one function of the set of function;
the method further comprises performing a simulation of the behavior using the set of functions as modified; and
the graphical representation comprises a display of a result of the simulation.

6. The method of claim 5, further comprising:
identifying a weather data source associated with a location of a real-world environment associated with the physical structure,
wherein performing the simulation comprises simulating an effect of weather on the physical structure using weather data from the weather data source.

7. The method of claim 1, wherein the remote device is an on-premise controller device installed at a real-world environment associated with the physical structure.

8. A device for providing a live visualization, the device comprising:
a memory capable of storing a digital twin;
a communication interface;
a user interface; and
a processor configured to:
receive, via a first user interface scene presented via the user interface, a user specification of a physical structure;
commit a data representation of the physical structure to a digital twin in the memory;
transmit the digital twin to a remote device via the communication interface;
receive an update to the digital twin from the remote device, producing an updated digital twin; and
render, via a second user interface scene presented via the user interface, a graphical representation of the updated digital twin.

9. The device of claim 8, wherein:
the update comprises at least one live value from a real-world environment represented by the digital twin, and
the graphical representation comprises a graphical representation of the at least one live value.

10. The device of claim 9, wherein the at least one live value comprises at least one live measurement, the processor being further configured to:
use the at least one live measurement to interpolate measurement values across the physical structure,
wherein the graphical representation comprises a graphical overlay representing the measurement values across the physical structure.

11. The device of claim 10, wherein the processor is further configured to receive a user specification of a measurement device location relative to the physical structure;
wherein, in using the at least one live measurement to interpolate measurement values across the physical structure, the processor is configured to associating a measurement of the at least one live measurement with the device location.

12. The device of claim 8, wherein:
the digital twin comprises a set of functions modeling a behavior associated with the physical structure;
the update comprises a modification of at least one function of the set of function;
the processor is further configured to perform a simulation of the behavior using the set of functions as modified; and
the graphical representation comprises a display of a result of the simulation.

13. The device of claim 12, wherein the processor is further configured to:
identify a weather data source associated with a location of a real-world environment associated with the physical structure,
wherein, in performing the simulation, the processor is configured to simulate an effect of weather on the physical structure using weather data from the weather data source.

14. The device of claim 8, wherein the remote device is an on-premise controller device installed at a real-world environment associated with the physical structure.

15. A non-transitory machine-readable medium encoded with instructions for execution by a processor for providing a live visualization, the non-transitory machine-readable medium comprising:
instructions for receiving, via a first user interface scene, a user specification of a physical structure;
instructions for committing a data representation of the physical structure to a digital twin;
instructions for transmitting the digital twin to a remote device;
instructions for receiving an update to the digital twin from the remote device, producing an updated digital twin; and
instructions for rendering, via a second user interface scene, a graphical representation of the updated digital twin.

16. The non-transitory machine-readable medium of claim 15, wherein:
the update comprises at least one live value from a real-world environment represented by the digital twin, and
the graphical representation comprises a graphical representation of the at least one live value.

17. The non-transitory machine-readable medium of claim 16, wherein the at least one live value comprises at least one live measurement, the non-transitory machine-readable medium further comprising:
instructions for receiving using the at least one live measurement to interpolate measurement values across the physical structure,
wherein the graphical representation comprises a graphical overlay representing the measurement values across the physical structure.

18. The non-transitory machine-readable medium of claim 17, further comprising instructions for receiving receiving a user specification of a measurement device location relative to the physical structure;
wherein the instructions for receiving using the at least one live measurement to interpolate measurement values across the physical structure comprise instructions for receiving associating a measurement of the at least one live measurement with the device location.

19. The non-transitory machine-readable medium of claim 15, wherein:
the digital twin comprises a set of functions modeling a behavior associated with the physical structure;
the update comprises a modification of at least one function of the set of function;
the non-transitory machine-readable medium further comprises instructions for performing a simulation of the behavior using the set of functions as modified; and
the graphical representation comprises a display of a result of the simulation.

20. The non-transitory machine-readable medium of claim 19, further comprising:
instructions for identifying a weather data source associated with a location of a real-world environment associated with the physical structure,
wherein the instructions for performing the simulation comprise instructions for simulating an effect of weather on the physical structure using weather data from the weather data source.
